(19) United States
(12) Patent Application Publication
(10) Pub. No.: US 2016/0279527 A1
(43) Pub. Date: Sep. 29, 2016

(54) INFORMATION PROCESSING DEVICE, INFORMATION PROCESSING SYSTEM, PROGRAM, AND RECORDING MEDIUM

(71) Applicant: KONAMI DIGITAL ENTERTAINMENT CO., LTD., Tokyo (JP)

(72) Inventor: Kosuke NISHIOKA, Tokyo (JP)

(21) Appl. No.: 15/178,691

(22) Filed: Jun. 10, 2016

Related U.S. Application Data
(63) Continuation of application No. PCT/JP2014/079829, filed on Nov. 11, 2014.

(30) Foreign Application Priority Data
Dec. 13, 2013 (JP) 2013-257934

(51) Int. Cl. A63F 13/822; A63F 13/45

(52) U.S. Cl. CPC A63F 13/822; A63F 13/45

(57) ABSTRACT

An embodiment of an information processing device according to the present invention is configured to be accessible to a storage device storing first object group information indicating a first object group including a plurality of first objects to be used by a user in a match-up. an information processing includes: selection means configured to select a second object based on an operation by the user; association means configured to associate the second object selected by the selection means with the user; obtainment means configured to obtain the first object group information associated with the user from the storage device; and output means configured to output output data based on information obtained as a result of processing a match-up performed between the first object group obtained by the obtainment means and the second object, the output data causing the user to recognize a content of the match-up.

### TECHNICAL FIELD

The present invention relates to a technology of information processing using an object.

### BACKGROUND ART

In recent years, so-called social games have been popular as applications to be run in social networking services (SNSs). As disclosed in Japan Laid-open Patent Application Publication No. 2013-000498, a type of game utilizing a character as an object has been known as an example of the aforementioned social games.

In this type of games, there is a match-up game that a user plays a match-up with a match-up opponent (the other user or an NPC (Non-Player Character)) using a predetermined number of objects. In this type of match-up game, selection of an object to be used in the match-up is an important factor regarding whether a user wins or loses the match-up. Hence, the user selects the object to be used in the match-up in consideration of the strength, attribute and so forth of the object.

### SUMMARY OF INVENTION

### Technical Problems

When an object is given to a user in the aforementioned match-up game, information (for instance, attack power, defense power, skill, etc.), which is set for the object, is configured to be displayed under some circumstances. By visually referring to the information, the user can recognize objective indexes of the given object. However, in some match-up methods to be performed in the match-up game, it is difficult to recognize whether or not the obtained object is effectively usable in match-ups only with reference to the objective indexes described above.

The present invention has been provided in view of the aforementioned perspective and is intended to provide an information processing device, an information processing system, a program and a recording medium that enable a user to determine whether or not an object associated with the user is effectively usable in a match-up.

### Solution to Problems

An aspect of the present invention relates to an information processing device configured to be accessible to a storage device storing first object group information indicating a first object group including a plurality of first objects to be used by a user in a match-up. The information processing device includes:

selection means configured to select a second object based on an operation by the user;

association means configured to associate the second object selected by the selection means with the user;

obtainment means configured to obtain the first object group information associated with the user from the storage device; and

output means configured to output output data based on information obtained as a result of processing a match-up performed between the first object group obtained by the obtainment means and the second object, the output data causing the user to recognize a content of the match-up.

Another aspect of the present invention relates to an information processing system. The information processing system includes a user terminal and a server configured to be accessed from the user terminal. At least one of the user terminal and the server is configured to be accessible to a storage device storing first object group information indicating a first object group including a plurality of first objects to be used by a user in a match-up. At least one of the user terminal and the server includes:

selection means configured to select a second object based on an operation by the user;

association means configured to associate the second object selected by the selection means with the user;

obtainment means configured to obtain the first object group information associated with the user from the storage device; and

output means configured to output output data based on information obtained as a result of processing a match-up performed between the first object group obtained by the obtainment means and the second object, the output data causing the user to recognize a content of the match-up.

Yet another aspect of the present invention relates to a program configured to cause a computer to implement a plurality of means. The computer is configured to be accessible to a storage device storing first object group information indicating a first object group including a plurality of first objects to be used by a user in a match-up. The plurality of means include:

selection means configured to select a second object based on an operation by the user;

association means configured to associate the second object selected by the selection means with the user;

obtainment means configured to obtain the first object group information associated with the user from the storage device; and

output means configured to output output data based on information obtained as a result of processing a match-up performed between the first object group obtained by the obtainment means and the second object, the output data causing the user to recognize a content of the match-up.

Further yet another aspect of the present invention relates to a non-transitory computer-readable recording medium. The recording medium includes a program enabling a computer to execute a method.

The method is configured to be executed by access to a storage device storing first object group information indicating a first object group including a plurality of first objects to be used by a user in a match-up.

The method includes:

selecting a second object based on an operation by the user;

associating the second object selected by the selection means with the user;

obtaining the first object group information associated with the user from the storage device; and

outputting output data based on information obtained as a result of processing a match-up performed between the obtained first object group and the second object, the output data causing the user to recognize a content of the match-up.

### BRIEF DESCRIPTION OF THE DRAWINGS

FIG. 1 is a diagram showing a basic configuration of a game system of a first embodiment.

FIG. 2 is a block diagram showing a configuration of a user terminal of the first embodiment.

FIG. 3 is a block diagram showing a configuration of a game server of the first embodiment.

FIG. 4 is a diagram for explaining a principle of a mock match-up in the first embodiment.

FIG. 5 is a diagram showing an exemplary configuration of a user data table.

FIG. 6 is a diagram showing an exemplary configuration of a card data table.

FIG. 7 is a diagram showing an exemplary configuration of a possessed card data table.

FIG. 8 is a diagram showing an exemplary configuration of a deck data table.

FIG. 9 is a diagram for explaining a match-up field in a game of the first embodiment.

FIG. 10 is a diagram showing an example of a series of images configured to be displayed on the user terminal when a user builds his/her own deck in the game of the first embodiment.

FIG. 11A is a diagram showing an example of a series of images configured to be displayed on the user terminal when a match-up is played between users in the game of the first embodiment.

FIG. 11B is a diagram showing an example of a series of images configured to be displayed on the user terminal when a match-up is played between users in the game of the first embodiment.

FIG. 11C is a diagram showing an example of a series of images configured to be displayed on the user terminal when a match-up is played between users in the game of the first embodiment.

FIG. 12 is a diagram for explaining forward movement of a card in a match-up.

FIG. 13 is a diagram for explaining transverse movement of cards in a match-up.

FIG. 14A is a diagram sequentially showing an example of the movement aspect of respective cards from the beginning to the end of a match-up.

FIG. 14B is a diagram sequentially showing an example of the movement aspect of the respective cards from the beginning to the end of the match-up.

FIG. 14C is a diagram sequentially showing an example of the movement aspect of the respective cards from the beginning to the end of the match-up.

FIG. 15 is a diagram showing an example of a series of images configured to be displayed on the user terminal when card drawing is performed with a mock match-up in the game of the first embodiment.

FIG. 16 is a functional block diagram of a game control device of the first embodiment.

FIG. 17 is a diagram showing an example of a data configuration of match-up processing data.

FIG. 18 is a flowchart showing an example of a match-up processing in the game of the first embodiment.

FIG. 19 is a flowchart showing an example of an attack processing.

FIG. 20 is a flowchart showing an example of a processing of forwardly moving cards.

FIG. 21 is a flowchart showing an example of a processing of transversely moving cards of a match-up opponent.

FIG. 22 is a flowchart showing an example of a processing of transversely moving cards of a user.

FIG. 23 is a diagram showing a modification of the movement aspect of the respective cards during a match-up.

FIG. 24 is a sequential chart showing an example of a drawing processing of the first embodiment.

FIG. 25 is a diagram showing a modification of images configured to be displayed on the user terminal in a processing to be performed when the user plays a mock match-up.

FIG. 26 is a sequential chart showing an example of a processing to be performed when the user plays the mock match-up again in a drawing processing according to the modification.

FIG. 27 is a diagram showing a modification of images configured to be displayed on the user terminal in the processing to be performed when the user plays the mock match-up again.

### DESCRIPTION OF EMBODIMENTS

### (1) First Embodiment

A game system according to a first embodiment of an information processing system of the present invention will be hereinafter explained. It should be noted that in the following explanation, image data will be described as an example of output data, but the output data is not limited to the image data, and may be text data, audio data or a combination of at least any of these types of data and the image data.

(1-1) Configuration of Game System

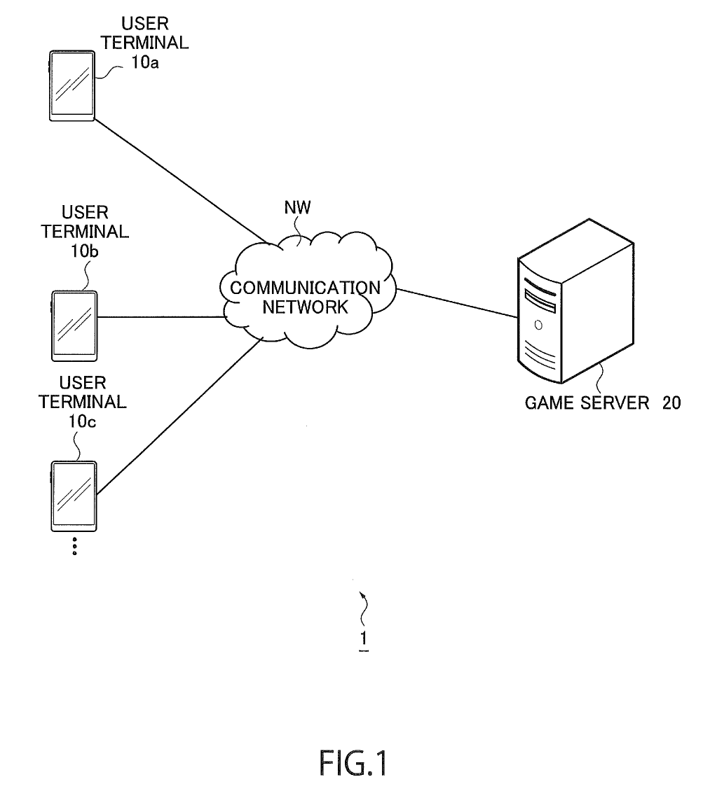

FIG. 1 shows an example of a system configuration of a game system 1 according to the present embodiment. As shown in FIG. 1, the present game system 1 includes user terminals 10a, 10b, 10c and so forth and a game server 20. The user terminals 10a, 10b and 10c are respectively accessible to the game server 20 through a communication network NW such as the Internet or so forth. It should be noted that the game system 1 is an example of the information processing system. On the other hand, the game server 20 is an example of an information processing device.

Each of the user terminals 10a, 10b, 10c and so forth is a terminal configured to be operated by an individual user, and is a communication terminal such as a feature phone, a smart phone, a tablet terminal, a personal computer, a television set equipped with a bidirectional communication function (including a so-called multi-functional smart television set) and a portable game console equipped with a communication function. In the following explanation, when commonly mentioned, the user terminals 10a, 10b, 10c and so forth will be referred to as user terminals 10.

The game server 20 is a server configured to run a game. A program capable of creating image data interpretable by a web browser (the image data refers to, for instance, the one described in the form of HTML, XML or so forth, and in the embodiment of the present invention, HTML data will be explained as an example of the image data) is implemented in the game server 20.

Each user terminal 10 includes a web browser configured to interpret and display the HTML data to be provided thereto from the game server 20, and is configured to perform a processing of the game by sending a request based on an operation performed by a user on a web page to the game server 20 through the network and by receiving a result of processing by the game server 20.

The communication network NW is, for instance, the Internet, a WAN (Wide Area Network), a LAN (Local Area Network), an exclusive line or an information communication network composed of a combination of these communication means.

(1-2) Configuration of User Terminal

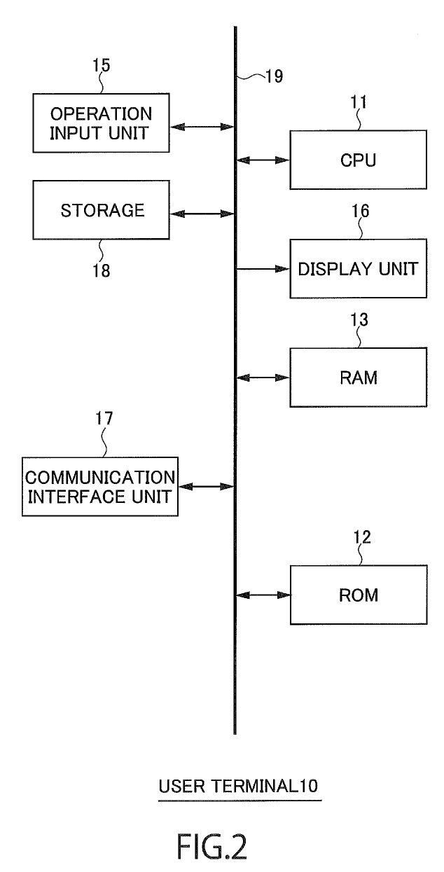

The user terminals 10 will be explained with reference to FIG. 2.

As shown in FIG. 2, each user terminal 10 includes a CPU (Central Processing Unit) 11, a ROM (Read Only Memory) 12, a RAM (Random Access Memory) 13, an operation input unit 15, a display unit 16, a communication interface unit 17 and a storage 18. Each terminal 10 is provided with a bus 19 for transmitting control signals or data signals among the respective constituent elements.

The CPU 11 is configured to read out programs and data stored in the ROM 12 and control an entire action to be performed in each user terminal 10 such as timing processing of control signals and data signals with the respective constituent elements in each user terminal 10. The CPU 11 is also configured to read out programs and a variety of data required for running the programs, which are stored in the storage 18, to the RAM 13 and perform a variety of processing such as data input-output processing, computational processing and determination processing in conjunction with running of the programs. The RAM 13 is configured to temporarily store data for the computational processing, the determination processing and so forth to be performed by the CPU 11.

For example, the CPU 11 is configured to load the web browser stored in the storage 18 to the RAM 13 and run the loaded web browser. Then, the CPU 11 is configured to obtain data for displaying a web page, i.e., data including an HTML (HyperText Markup Language) document and an object such as an image associated with the HTML document (the HTML document and the object will be hereinafter collectively referred to as “HTML data” on an as-needed basis) from the game server 20 through the communication interface unit 17 based on a URL (Uniform Resource Locator) specified by a user through the operation input unit 15 or so forth, and is configured to interpret the HTML data by running the web browser. It should be noted that various plug-ins may be implemented in each user terminal 10 for extending the browsing function of the web browser. An example of the plug-ins is Adobe Flash Player of Adobe Systems Incorporated in the United States. Alternatively, the HTML data in the present embodiment may be described in the form of HTML 5 equipped with a function of playing movies and sounds.

The web browser is configured to communicate with the game server 20 via HTTP (HyperText Transfer Protocol). When the URL (Uniform Resource Locator) or an operating target (for instance, a software button (hereinafter simply referred to as “button”), etc.) is selected on the web page through an operation of the operation input unit 15 by a user, the web browser is configured to send an HTTP request including the result of this selection to the game server 20 in order to update the web page. The web browser is configured to obtain the HTML data as an HTTP response from the game server 20, interpret the HMTL data, and display an image of the web page on the display unit 16.

In the present embodiment, the HTML data is an example of the image data.

The display unit 16 is a display device such as an LCD (Liquid Cristal Display) or an organic EL (Electro Luminescence) display, and is configured to display an image of a web page on a display screen 16a.

When each user terminal 10 is a user terminal of a button input type, the operation input unit 15 is provided with, for instance, a plurality of instruction input buttons for accepting an operational input from a user such as direction instruction buttons, a select button and numeric keys, and includes an interface circuit for recognizing a press (operation) input of each button and outputting the recognized press input to the CPU 11.

When each user terminal 10 is a user terminal of a touch panel input type, the operation input unit 15 is configured to mainly accept a touch panel type input to be performed by touching a display screen with a finger or a pen.

The storage 18 is a memory device composed of, for instance, a flash memory or an HDD (Hard Disk Drive).

(1-3) Configuration of Game Server

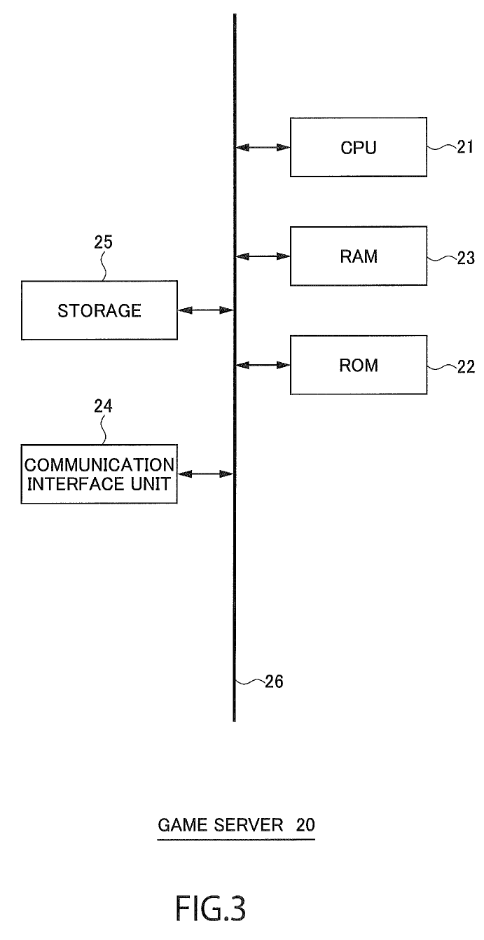

A configuration of the game server 20 will be explained with reference to FIG. 3.

As shown in FIG. 3, the game server 20 includes a CPU 21, a ROM 22, a RAM 23, a communication interface unit 24 and a storage 25. The game server 20 is provided with a bus 26 for transmitting control signals or data signals among the respective constituent elements. It should be noted that the game server 20 can employ the same hardware configuration as a network server for general use.

The CPU 21 is configured to read out programs and data stored in the ROM 22 and control an entire action to be performed in the game server 20 such as timing processing of control signals and data signals with the respective constituent elements in the game server 20. The CPU 21 is also configured to read out programs and a variety of data required for running the programs, which are stored in the storage 25, to the RAM 23 and perform a variety of processing such as data input-output processing, computational processing and determination processing in conjunction with running of the programs. The RAM 23 is configured to temporarily store data for the computational processing, the determination processing and so forth to be performed by the CPU 21.

For example, the storage 25 stores a program for providing each user terminal 10 with a web service by communicating with the browser of each user terminal 10 as a client via HTTP. The CPU 21 is configured to load the program stored in the storage 25 to the RAM 23 and run the loaded program. In conjunction with running of the program, the CPU 21 is configured to obtain an HTTP request from each user terminal 10 through the communication interface unit 24, perform processing in accordance with the HTTP request, and return HTML data including the result of the processing as an HTTP response to each user terminal 10.

The storage 25 is a memory device composed of, for instance, a flash memory or an HDD (Hard Disk Drive), and stores a data table group in addition to the aforementioned program. The data table group includes a user data table, a card data table, a possessed card data table and a deck data table. The respective data tables in the storage 25 are accessed by the CPU 21 for data reading and data writing on an as-needed basis.

(1-4) Mock Match-up in Present Embodiment.

A game configured to be run in the game system 1 of the present embodiment is a game in which a user uses cards as objects. In this game, for instance, a user plays a match-up with other user or an NPC with use of cards and/or items obtained in the game or from other user or with use of cards possessed by the user. A single or plurality of cards to be used by the user in a match-up (hereinafter referred to as “match-up use cards” on an as-needed basis) is/are configured to be selected from cards possessed by the user (possessed cards) based on an operation of the user or in an automatic manner.

In the present embodiment, the term “mock match-up” refers to a match-up to be played between one or more match-up use cards of a user and one or more cards obtained or supposed to be obtained by the user. The following methods may be provided as methods of obtaining one or more cards by a user: a method of obtaining one or more cards during running of the game; and a method of obtaining one or more cards at timing other than during running of the game. The method of obtaining one or more cards during running of the game may be arbitrarily set, and for instance, the following conditions are assumed for this method: a user is given one or more cards with a predetermined or random probability during searching an area in the game; a user is given one or more cards as reward in completing a predetermined stage; and a user is randomly given one or more cards in performing drawing processing. The following conditions are assumed for the method of obtaining one or more cards at timing other than during running of the game: a user obtains one or more cards when given the card or cards by other user as a present; and a user obtains one or more cards as a result of exchange (trade) of his/her card or cards with other card or cards.

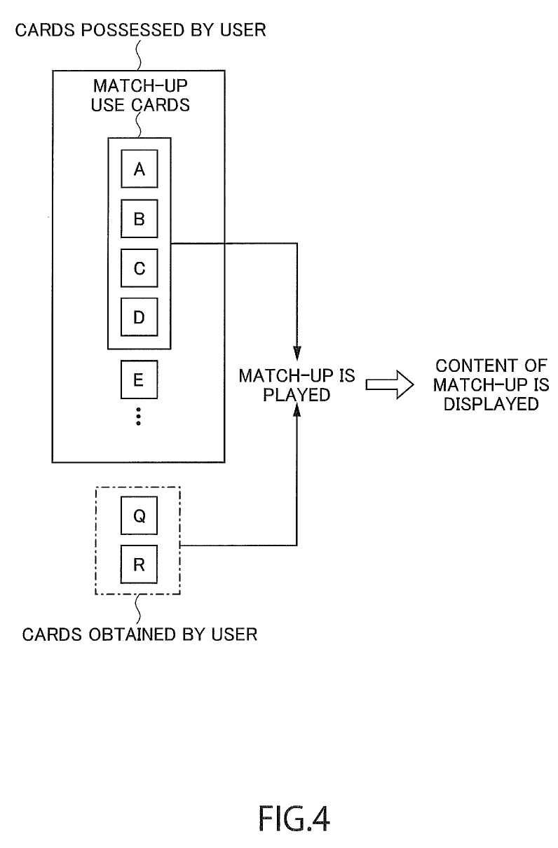

FIG. 4 is a diagram for explaining a principle of the mock match-up in the present embodiment. In FIG. 4, it is assumed that cards A to D are match-up use cards of a user among cards possessed by the user. It is also assumed that the user has obtained cards Q and R. In FIG. 4, it is assumed that the number of cards obtained by the user (hereinafter referred to as “obtained cards”) is two. However, the number of the obtained cards of the user is not particularly limited, and may be one.

When obtaining the cards Q and R, the user cannot immediately recognize whether or not the cards Q and R are effective cards for match-ups. For example, when each card Q, R is composed of a relatively simple parameter (e.g., attack power) and a simple match-up rule is set such that a result of the match-up is determined by the magnitude of attack power, chances are that the user can get a sense of whether or not the obtained card should be incorporated into the match-up use cards only by checking the attack power of the obtained card. However, in many match-ups, extent to which the card effectively works in match-ups depends on a plurality of parameters associated with the card, a region on which the card is placed, or so forth. This is because when there are a plurality of regions in which a card can be placed, the attack power or so forth of the card may be configured to be changed in accordance with which one of the plural regions the card is placed in. Therefore, when a mock match-up is played between a match-up use card of the user and an obtained card of the user and then the content of the mock match-up is displayed in a manner recognizable by the user, the user can more appropriately judge whether or not the obtained card is effective card for match-ups. For example, when the obtained card wins the match-up use card or when the obtained card loses the match-up use card in spite of a good fight, the user can judge that the obtained card can be incorporated into the match-up use cards.

It should be noted that suppose a mock match-up is played between an obtained card of a user and an NPC, the user does not know the strength of the NPC. Hence, even when visually confirming the content of the match-up, the user cannot appropriately judge whether or not the obtained card can be effectively used in the subsequent match-ups. On the other hand, in a mock match-up between an obtained card of a user and a match-up use card of the user, the user grasps the strength of his/her own match-up use card in match-ups. Hence, by visually confirming the content of the mock match-up, it becomes easy for the user to recognize the relative strength of the obtained card of the user with respect to the match-up use card that has been normally used by the user.

The setting of a match-up between users and that of a mock match-up are not particularly limited in the game. In the game of the present embodiment to be hereinafter explained, a setting will be exemplified that a match-up is played between users using card decks (hereinafter simply referred to as “decks” on an as-needed basis) built by the respective users based on a plurality of user usage cards. In this case, similarly to the match-up between users, a mock match-up is played using card decks. As described below, in a match-up using card decks, the motion of each card is relatively complex during the match-up due to parameters associated with the card, regions in which the card can be placed, and so forth. Thus, the match-up using card decks is an exemplary match-up game in which a user has difficulty in recognizing effectiveness of a card in a match-up unless the user checks the content of the match-up.

(1-5) Configuration of Data Table Group

The respective data tables stored in the storage 25 will be hereinafter explained.

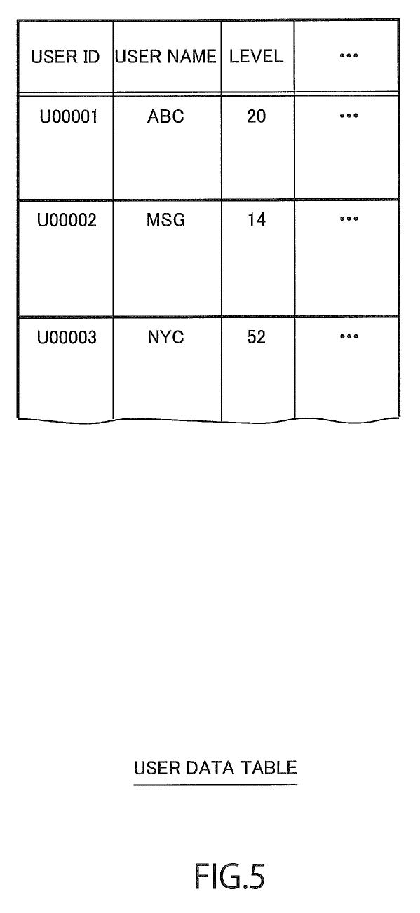

(1-5-1) User Data Table (FIG. 5)

FIG. 5 shows an example of a user data table 31 to be applied in the game of the present embodiment. In this example, the user data table 31 contains information of the respective attributes for each user ID (user identification information), and the attributes are composed of user name, user image, game level, available cost and possessed cards. The information contained in the user data table 31 can be updated by the game server 20 on an as-needed basis.

In the following explanation, collection of data for each user ID contained in the user data table will be collectively referred to as user data. Collection of data of the respective attributes, which composes the user data exemplified in FIG. 5, is as follows. It should be noted that excluding these attributes, other parameters to be associated with a user in the game and so forth may be set on an as-needed basis.

User Name

The attribute User-name is defined as a user name configured to be displayed for specifying a user of each user terminal 10 during running of the game. For example, the value of the attribute User-name is a text having a predetermined length or less and is configured to be preliminarily assigned by a user. The value of the attribute User-name is a name for specifying a user in a network environment (or a game community) provided by the game server 20.

Game Level

The attribute Game-level is defined as data for indicating progression of a user in the game, and the value thereof is configured to be increased with progression of the user in the game. In the game of the present embodiment, the value of the attribute Game-level is configured to be increased in accordance with a preliminarily set rule. For example, the value of the attribute Game-level may be configured to be increased with increase in number of wins of a user in match-ups or increase in winning rate of a user in match-ups.

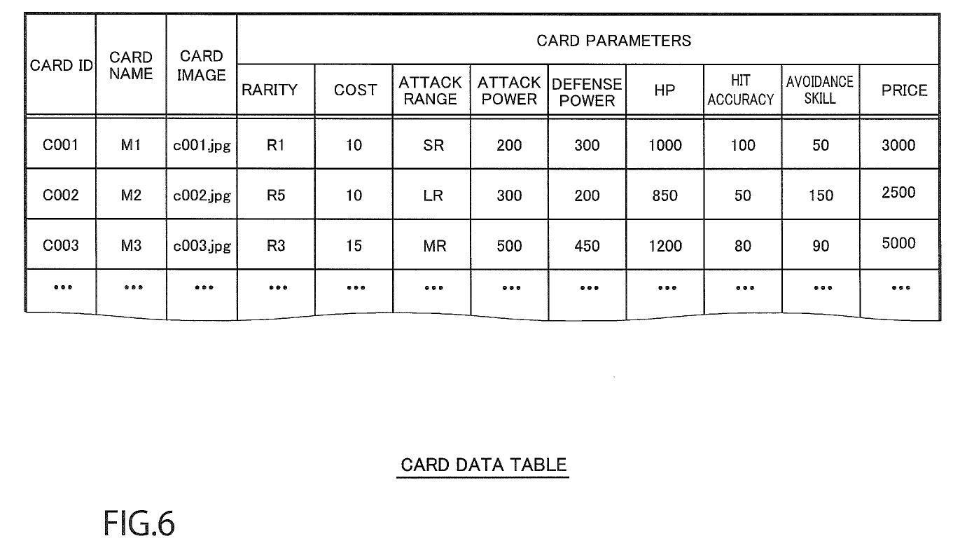

(1-5-2) Card Data Table (FIG. 6)

FIG. 6 shows an exemplary configuration of the card data table. As shown in FIG. 6, the card data table contains collection of data for each card ID (also hereinafter collectively referred to as “card data” on an as-needed basis) regarding attributes Card-name, Card-image and Card-parameters (Rarity, Cost, Attack-range, Attack-power, Defense-power, HP, Hit-accuracy, Avoidance-skill and Price). Contents of the respective attributes are as follows.

Card Name

A given card is associated with a character, and the attribute Card-name is defined as information of the name (M3, M8, etc.) of a monster character configured to be displayed on the given card.

Card Image

The attribute Card-image is defined as an image of a character configured to be displayed on a given card in a game image. The JPEG format exemplified in FIG. 6 is only an exemplary file format for card images, and other file format (GIF, etc.) may be used instead.

Rarity

The attribute Rarity is defined as a parameter indicating the extent of rarity of a given card. In the example shown in FIG. 6, card rarity becomes higher in the order of R1 to R5.

Cost

The attribute Cost is defined as a parameter configured to be referred by a user in considering whether or not a given card should be incorporated into his/her own card deck. In the game of the present embodiment, sum of the values of the attribute Cost for cards included in the card deck may be configured to be limited to be a predetermined value or less. It should be noted that the value of the attribute Cost may be set to be higher with increase in value of the attribute Attack-power for a card, but the setting of the attribute Cost is not limited to this.

Attack Range

The attribute Attack-range is defined as a parameter indicating an attack range of a given card, in which the given card performs best in attack. The value of the attribute Attack-range of the given card is any of “SR” (short range), “MR” (middle range) and “LR” (long range). The attribute Attack-range is an example of layout information of an object.

Attack Power

The attribute Attack-power is defined as a parameter indicating attack power of a given card in a match-up. With increase in value of the attribute Attack-power, the value of the attribute HP of an opponent card as an attack target can be reduced more.

Defense Power

The attribute Defense-power is defined as a parameter indicating defense power of a given card against attack by a given opponent card in a match-up. With increase in value of the attribute Defense-power, the value of the attribute HP of the given card becomes unlikely to be reduced against attack by the given opponent card in a match-up.

HP

The attribute HP is defined as a parameter indicating the initial stamina of a given card in a match-up. When the given card is attacked by a given opponent card during a match-up and the value of the attribute HP of the given card becomes zero, the given card is configured to disappear in the match-up.

Hit Accuracy

The attribute Hit-accuracy is defined as a parameter indicating how accurately attack of a given card hits a given opponent card as an attack target. With increase in value of the attribute Hit-accuracy, attack of the given card more accurately hits the given opponent card.

Avoidance Skill

The attribute Avoidance-skill is defined as a parameter indicating the magnitude of skill of a given card to avoid attack by a given opponent card. With increase in value of the attribute Avoidance-skill, the given card becomes unlikely to be attacked by the given opponent card.

Price

The attribute Price is defined as a value indicating the price of a given card in a virtual currency in selling the given card in the game.

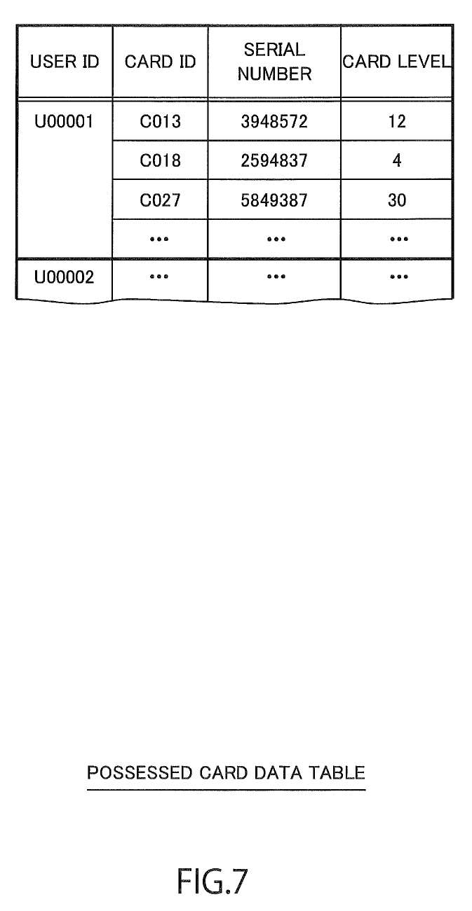

(1-5-3) Possessed Card Data Table (FIG. 7)

FIG. 7 shows an exemplary configuration of the possessed card data table. As shown in FIG. 7, in the possessed card data table, data (of attributes Card-ID, Serial-number and Card-level) of cards possessed by each user are associated with each user ID.

The attribute Serial-number is defined as a unique number configured to be determined at a point of time when a given card is given to a given user. Even when cards have the same card ID, different serial numbers are configured to be assigned to the cards.

The attribute Card-level is defined as a parameter (initial value: 1) indicating a rearing level of a given card. A method of card rearing is not particularly limited. For example, the value of the attribute Card-level of a specific card may be configured to be elevated by performing a processing of integrating the specific card and other card. It should be noted that in use of a given card, the parameters of the given card may be configured to be changed in accordance with the value of the attribute Card-level. For example, the value of the attribute Attack-power of a card C001 exemplified in FIG. 6 is set to be a fixed value of “200”, but may be configured to be changed as follows: the value of the attribute Attack-power is set to be “50” when the value of the attribute Card-level is “1”; the value of the attribute Attack-power is set to be “100” when the value of the attribute Card-level is “2”; . . . and the value of the attribute Attack-power is set to be “200” when the value of the attribute Card-level is “4” (maximum).

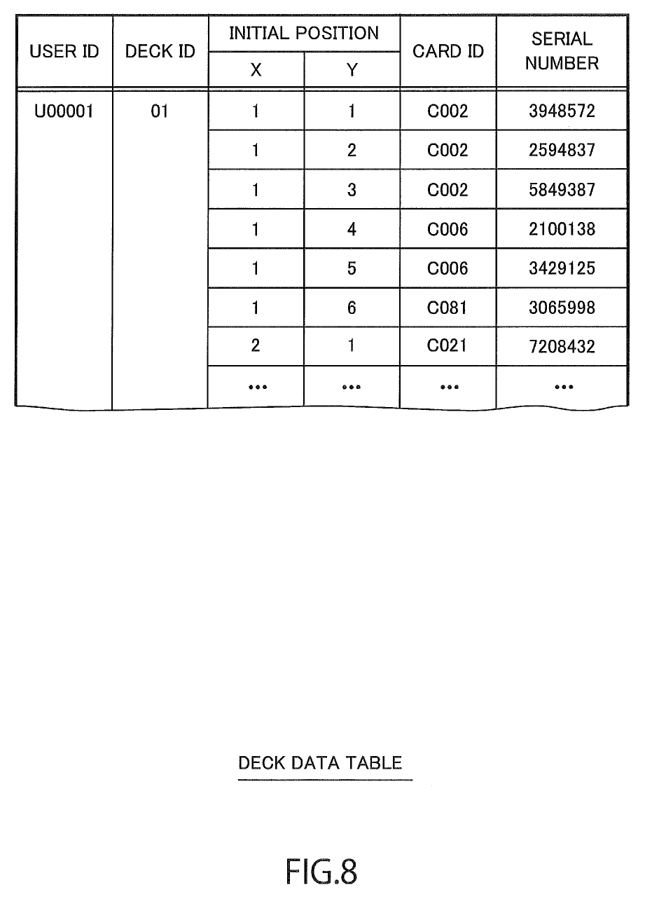

(1-5-4) Deck Data Table (FIG. 8)

FIG. 8 shows an exemplary configuration of the deck data table. In the example of FIG. 8, a plurality of decks to be specified by values of the attribute Deck-ID are configured to be recordable in association with a given value of the attribute User-ID. However, only a single deck may be configured to be recordable in association with the given value of the attribute User-ID. In association with a given value of the attribute Deck-ID, values of the attributes Initial-position, Card-ID and Serial-ID are recorded for cards located in cells on a match-up field to be described (respective positions in a 3×6 matrix expressed by coordinates (x, y) where x=1-3 and y=1-6). The deck data table indicates positions of cells in which cards are placed on the match-up field.

In a match-up of the game of the present embodiment to be described, a card deck to be used by a user in a match-up is read out from the deck data table, and match-up use cards included in the read-out card deck are respectively placed in any of cells on the match-up field to be described. Each card deck is associated with a given value of the attribute Deck-ID. As exemplified in FIG. 8, a plurality of card decks may be recorded in association with each user. It should be noted that the following explanation relates to a configuration that a single card deck is recorded in association with each user.

(1-6) Game of Present Embodiment

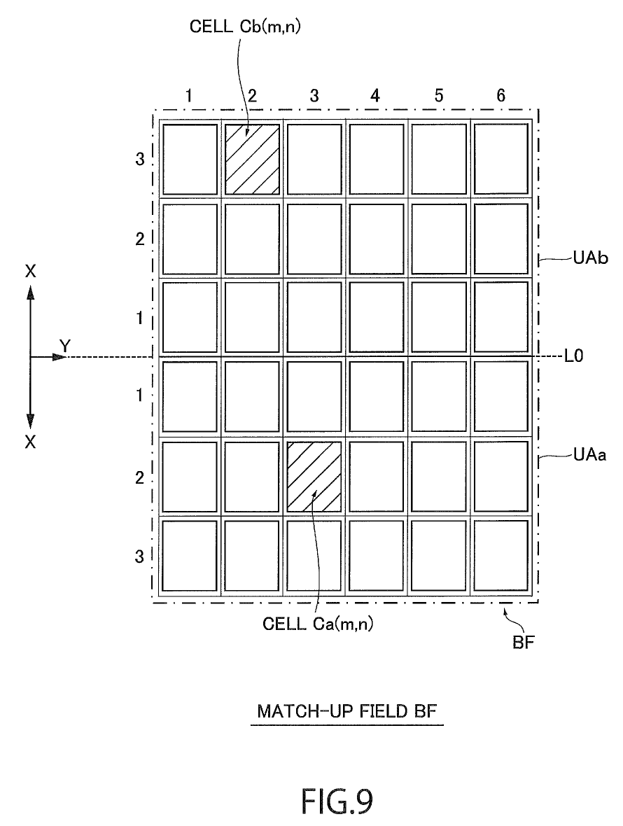

Next, the game of the present embodiment will be explained with reference to FIGS. 9 and 10, FIGS. 11A to 11B, FIGS. 12 and 13, and FIGS. 14A to 14C.

(1-6-1) Match-Up Field and Card Layout

In the game of the present embodiment, a match-up field is provided in a game space, and a match-up is played by card decks placed in any of the cells on the match-up field. The types of match-up include a match-up between card decks of different users, a match-up between a card deck of a user and an NPC, a match-up between a card deck of a user and a drawn card deck (the aforementioned mock match-up) and so forth. It should be noted that the term “drawn card deck” refers to a card deck composed of cards obtained by a user through drawing (hereinafter referred to as “drawn cards”). The match-up field is composed of a plurality of regions (cells) on which objects are allowed to be placed in a match-up. It should be noted that in the present embodiment, a single card is configured to be allowed to be placed in a single cell.

In the following explanation, on an as-needed basis, a user deck of a user as a target to be operated by each user terminal 10 will be referred to as “user deck” whereas a card deck as an opponent of the user in a match-up (including a drawn card deck) will be referred to as “opponent deck”. It should be noted that a match-up between users may be configured to be played in an asynchronous manner.

The match-up field will be explained with reference to FIG. 9. FIG. 9 is a diagram for explaining an example of a match-up field BF in the game of the present embodiment. As shown in FIG. 9, the match-up field BF includes a region UAa in which a user deck is placed and a region UAb in which an opponent deck is placed. In the example of FIG. 9, the region UAa is made in the form of a 3×6 matrix of cells Ca(m,n) where m is an integer of 1 to 3 and n is an integer of 1 to 6. The region UAb is made in the form of a 3×6 matrix of cells Cb(m,n) where m is an integer of 1 to 3 and n is an integer of 1 to 6. The user deck in the region UAa and the opponent deck in the region UAb are configured to be placed in any of the cells on the match-up field while being opposed on the both sides of a baseline L0. It should be noted that as shown in FIG. 9, the aforementioned “m” corresponds to a value of row with reference to the baseline L0, whereas the aforementioned “n” corresponds to a value of column with reference to the left end. The first row of the region UAa for the user deck and that of the region UAb for the opponent deck are respectively an example of a first base row and an example of a second base row. During the match-up, the respective cards of the user deck are configured to be moved within the region UAa, whereas the respective cards of the opponent deck are configured to be moved within the region UAb. However, the cards of the user deck and those of the opponent deck are configured not to be moved across the baseline L0.

It should be noted that in FIG. 9, the 3×6 matrix of cells are only an example of the form of each region UAa, UAb, and each region may be made in the form of a matrix of an arbitrary size.

In the following example, each region in the matrix may be referred to as “position”. Additionally, “layout position” of a card means a position in which the card is placed.

(1-6-2) Building of Deck

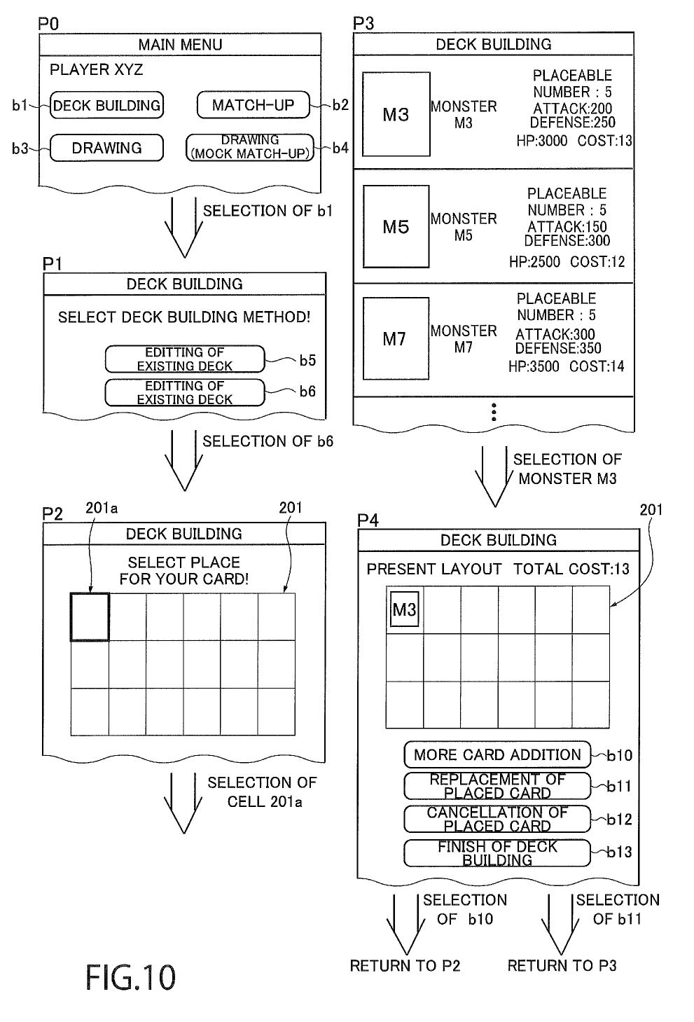

FIG. 10 is a diagram showing an example of a series of images configured to be displayed on each user terminal 10 when a user builds his/her own deck based on his/her possessed cards in the game of the present embodiment.

An example will be hereinafter explained that a user running the game has “XYZ” as his/her user name (the user will be hereinafter referred to as “user XYZ”).

In FIG. 10, an image P0 is an example of an image displaying a main menu of the game of the present embodiment. A button b1 (“deck building”) for allowing a user to build his/her own deck, a button b2 (“match-up”) for allowing a user to play a match-up with other user or an NPC, a button b3 (“drawing”) for allowing a user to obtain one or more cards through drawing and a button b4 (“drawing (mock match-up)”) are displayed on the image P0. The button b4 (“drawing (mock match-up)”) is a button with which after obtaining one or more cards through drawing, a user is allowed to play a mock match-up between a user deck and a deck built by the obtained card or cards (drawn card deck).

When the button b1 (“deck building”) is selected on the image P0, the image is updated as shown in P1. The image P1 includes a button b5 (“editing of existing deck”) and a button b6 (“building of new deck”) as buttons for selecting a method of building a user deck. The button b5 (“editing of existing deck”) is a button for editing a user deck that has been already recorded in the deck data table. The button b6 (“building of new deck”) is a button for building a new user deck.

When the button b6 (“building of new deck”) is selected on the image P1, the image is updated as shown in P2. A matrix 201, composed of a plurality of cells respectively corresponding to the cells of the region UAa in the game space, is displayed on the image P2. By performing an operation of selecting one of the cells in the matrix 201, the user XYZ can specify a cell in the region UAa in which he/she wants to place a card. In other words, layout of a card on the matrix 201 is reflected in layout of the card on the region UAa in the game space. For example, it is herein assumed that an operation of selecting a cell 201a in the matrix 201 is performed. In this case, the image is updated as shown in P3. The image P3 displays a list of cards possessed by the user XYZ, and any one of the cards in this list is configured to be selectable as a layout target. For example, when a card corresponding to a monster M3 is selected on the image P3, the image is updated as shown in P4. In the image P4, the matrix 201 is displayed in a condition in which the card selected on the image P3 is placed in the cell 201a.

At this time, the sum of the costs of placed cards (referred to as “total cost”) may be configured to be displayed as shown in the image P4. When the total cost of the cards to be placed in the region UAa by a user is limited to be a predetermined value or less, it is possible to produce a game setting that a user performs a card layout processing while paying attention to the value of the total cost to be displayed.

The image P4 may be provided with a button b10 (“more card addition”, a button b11 (“replacement of placed card”), a button b12 (“cancellation of placed card”) and a button b13 (“finish of deck building”).

The button b10 (“more card addition”) is a button for additionally placing a card in any of the cells in which no card is placed on the matrix 201. The button b11 (“replacement of placed card”) is a button for replacing the card, which has been already placed on the matrix 201, with other card. The button b12 (“cancellation of placed card”) is a button for canceling layout of the card that has been already placed on the matrix 201. The button b13 (“finish of deck building”) is a button for finishing deck building.

When the button b10 (“more card addition”) is selected on the image P4, the image is updated similarly to P2. In this example, the card has been already placed in the cell 201a. Hence, cells other than the cell 201a become selectable. By repeating update of the image in the sequential order of P2, P3, P4, P2 . . . , a user can sequentially place cards on the matrix 201.

When the button b11 (“replacement of placed card”) is selected in a condition in which any of the cards placed on the matrix 201 is selected on the image P4, the image is updated similarly to P3. Accordingly, other card is selectable as a card with which the selected placed card is replaced.

When the button b12 (“cancellation of placed card”) is selected in a condition in which any of the cards placed on the matrix 201 is selected on the image P4, the selected card is deleted from the matrix 201.

When the button b13 (“finish of deck building”) is selected on the image P4, the deck building processing is finished, and cards disposed on the matrix 201 so far are recorded as a new deck in the deck data table.

Detailed description will not be provided in a case in which a condition in which the button b5 (“editing of existing deck”) is selected on the image P1. Simply put, a card deck of a user recorded in the deck data table is read out and the image P2 is displayed in a condition in which the read-out card deck is placed on the matrix 201. Then, as shown in the image P4, addition, replacement, or cancellation of card layout is configured to be enabled on a cell basis.

(1-6-3) Progression of Match-up

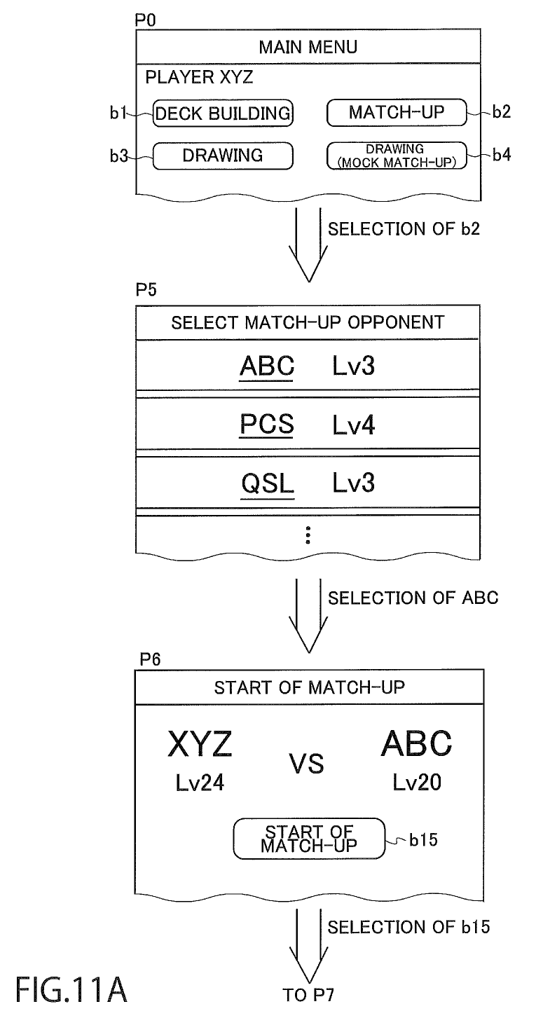

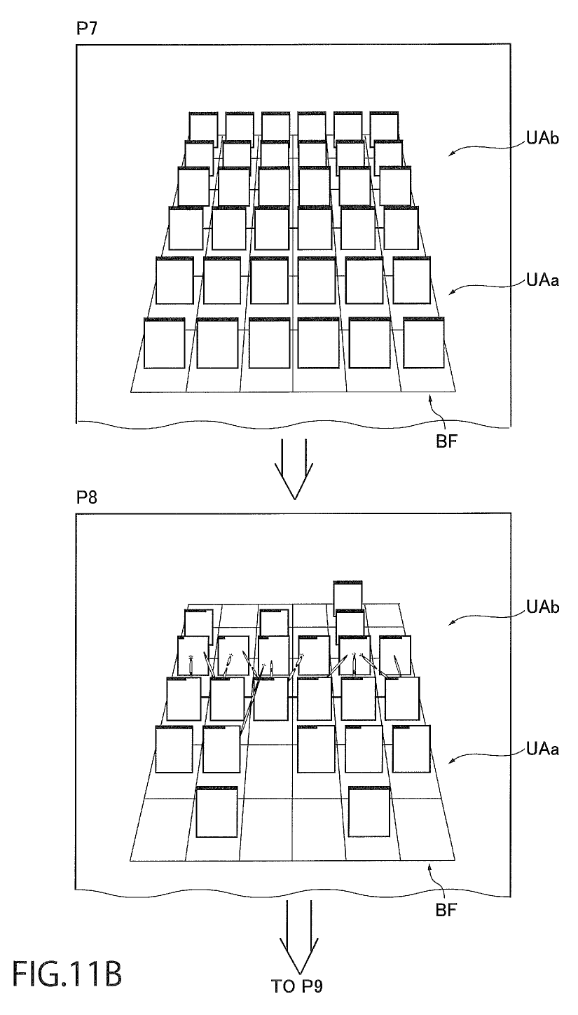

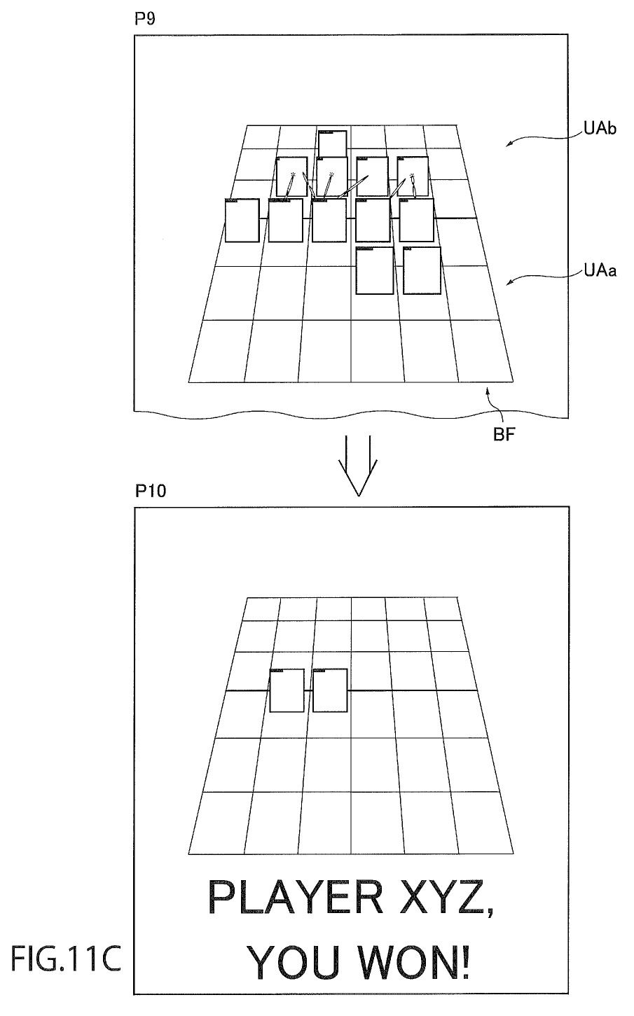

When the button b2 (“match-up”) is selected on the image P0 (main menu) of FIG. 11A, the image is updated as shown in P5.

In the image P5, a list of other users is displayed as match-up opponents. When any of the users is selected from the list as a match-up opponent, the image is updated as shown in P6. In this example, a setting is exemplified that a match-up is played between the user XYZ and a user ABC. When a button b15 (“start of match-up”) is selected on the image P6, the match-up is started between the user XYZ and the user ABC.

FIGS. 11B and 11C show an image P7 exemplifying a display condition in the beginning of a match-up, images P8 and P9 exemplifying a display condition during the match-up, and an image P10 exemplifying a display condition in the end of the match-up. Start-to-end images of the match-up may be configured to be played by animation. As shown in the image P7, when the match-up is played, for instance, an image of the match-up field BF seen from an obliquely upward point of view in the game space is displayed. In this example of the image, cards respectively placed in the cells on the match-up field BF are displayed while standing upright on the cells. This makes a user easily recognize the images on the respective cards. It should be noted that the images on the respective cards are not illustrated in FIGS. 11B and 11C.

As shown in the image P8, it is preferable to display an attack aspect such as irradiation of beams or release of flying objects from cards in an attack motion (attacker cards) to attack target cards during the match-up, whereby a user can recognize a situation that attack is being done by the respective cards of the user deck or the opponent deck. When a given card is attacked during the match-up and the value of HP becomes zero, the given card disappears from the match-up field. The value of HP remaining in each card (remaining HP to be described) is displayed in the form of a bar gauge displayed on the top end of each card. The image P9 shows a condition in which time has further elapsed from the point of time that the image P8 was displayed, and the number of cards on the match-up field has been reduced than in image P8.

As shown in the image P10, for instance, the match-up ends when all the cards in either of the user deck and the opponent deck disappear. In the example of the image P10, two cards of the user deck remain whereas all the cards of the opponent deck have disappeared. Therefore, the user becomes a winner. It should be noted that a condition for judging a winner is not necessarily limited to disappearance of all the cards in either deck. Alternatively, a given deck may be judged as a winner when the number of cards, remaining on the match-up field after a predetermined period of time in the match-up, is greater in the given deck than in the other deck.

In the match-up, an attack turn of the user deck and that of the opponent deck are alternately repeated. In each attack turn, cards remaining on the match-up field respectively attack in a sequential order.

Progression of the match-up will be hereinafter explained by exemplifying the attack turn of the user deck. However, this is also true of the attack turn of the opponent deck.

In the attack turn of the user deck, a given card of the opponent deck as an attack target (attack target card) and the value of attack power to be made on the given card are determined by the respective parameters associated with the attacker card including attack range, attack power and hit accuracy. In other words, a given card of the opponent deck, located within a predetermined range of distance from the attacker card, is specified as the attack target card, and the value of attack power to be made on the attack target card is determined by the attack range of the attacker card and the distance between the attacker card and the attack target card. Accordingly, the amount of reduction in HP of the attack target card is determined.

When the remaining HP of the attack target card becomes zero, the attack target card disappears from the match-up field. In some cases, when a given card disappears from the match-up field, cards, which remains on the match-up field and belongs to the same deck as the disappeared card, are moved in accordance with a predetermined rule. A method of moving one or more cards during a match-up will be hereinafter explained.

(1-6-4) Method of Moving Card during Match-up Battle

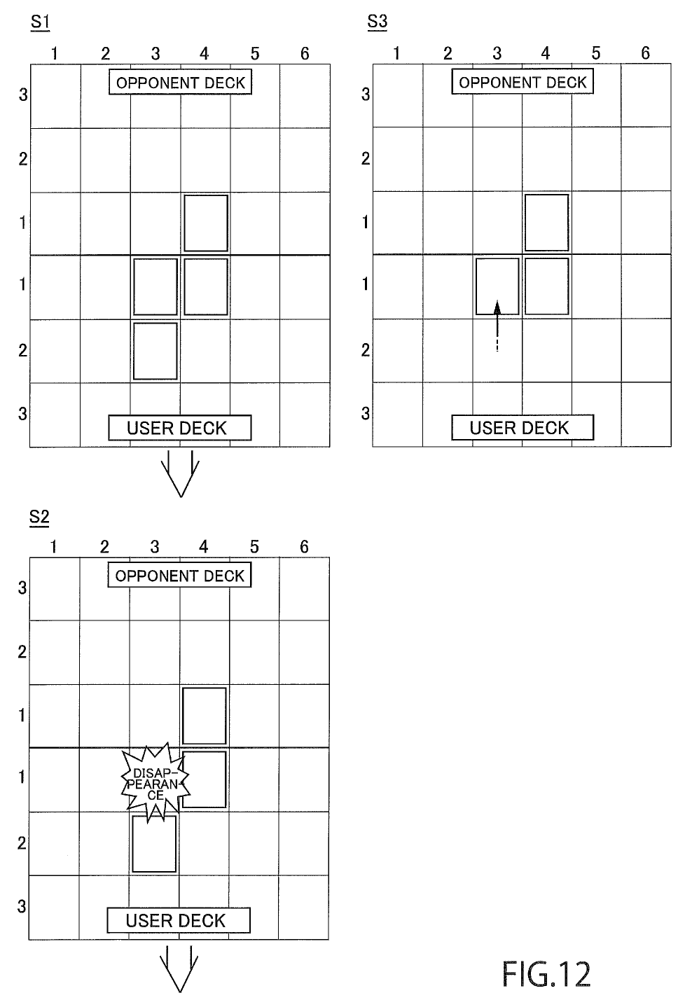

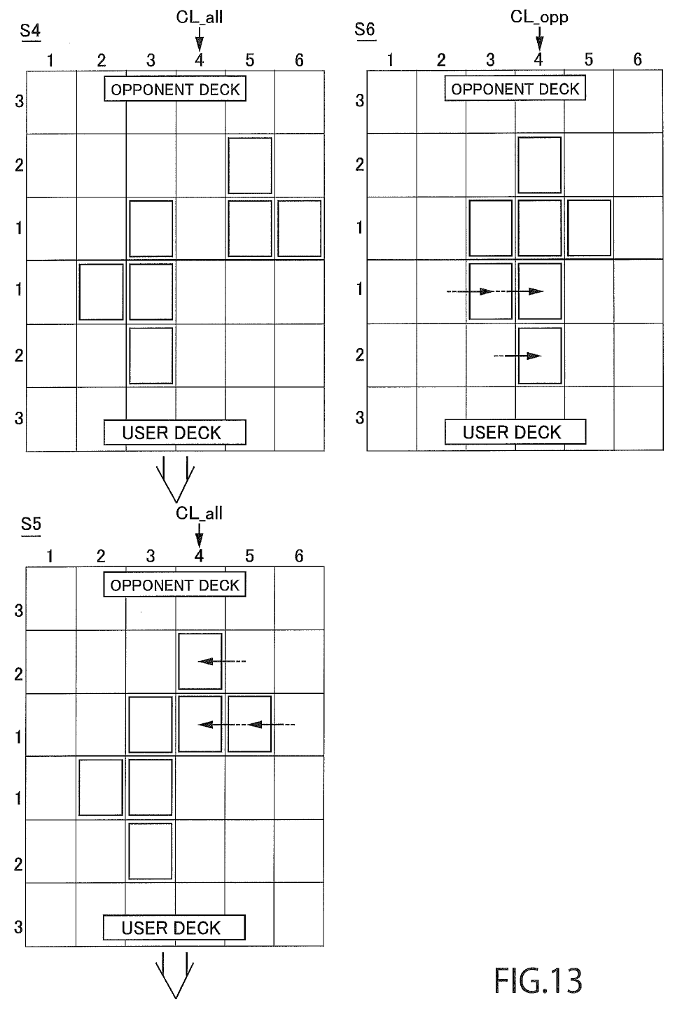

As described above, based on a moving method in accordance with a predetermined rule, each card is configured to be moved within a match-up field during a match-up. With reference to FIGS. 12 and 13, a method of forwardly moving one or more cards and a method of transversely moving one or more cards will be separately explained as the method of moving one or more cards. FIG. 12 is a diagram for explaining forward movement of a card in a match-up. FIG. 13 is a diagram for explaining transverse movement of cards in a match-up.

FIGS. 12 and 13 respectively show layouts of cards placed in the respective cells on a match-up field when the game space is seen in a plan view for explaining a movement aspect of one or more cards during a match-up.

It should be noted that in moving one or more cards during a match-up, forward movement is performed in priority to transverse movement.

Forward Movement of Card

In a match-up of the present embodiment, one or more cards placed in the first row of the region UAa for the user deck and one or more cards placed in the first row of the region UAb for the opponent deck are faced at the nearest distance, and hence, are likely to be attacked from each other, and thus, are likely to be reduced in value of HP earlier and disappear. In view of this, in the match-up of the present embodiment, when a given card placed in the first row disappears, a card located behind and in the same column as the disappeared card is moved forward. Thus, the cards respectively perform an action of sequentially moving forward during the match-up.

A specific example of forwardly moving a card will be explained with reference to FIG. 12. A card layout shown in S1 is herein assumed. In this card layout, when a card placed in a cell Ca(1,3) of the region UAa for the user deck is attacked and disappears (S2), a card placed in a cell Ca(2,3), which is placed behind the disappeared card, is forwardly moved to the first row (S3). It should be noted that although not illustrated in the drawing, when there is a card in a cell Ca(3,3) at the point of time in S1, the card is similarly configured to be moved to the forward cell Ca(2,3).

Transverse Movement of Card

In the following explanation, a column on the matrix, which indicates the middle position of a card group on the entire field, will be referred to as “entire card middle position (CL_all)”, whereas a column on the matrix, which indicates the middle position of a card group of the opponent deck, will be referred to as “opponent card middle position (CL_opp)”.

The entire card middle position means the column located in the middle of the column of the leftmost cell in which a given card is placed and the column of the rightmost cell in which a given card is plated on the match-up field. When the middle position between these columns is the middle of cells, the column located on the right side of the middle position is defined as the entire card middle position. It should be noted that when the middle position between these columns is the middle of cells, the column located on the left side of the middle position may be defined as the entire card middle position.

The opponent card middle position means the column located in the middle of the column of the leftmost cell in which a given card is placed and the column of the rightmost cell in which a given cards is placed in the region UAb for the opponent deck. When the middle position between these columns is the middle of cells, the column located on the left side of the middle position is defined as the opponent card middle position. It should be noted that when the middle position between these columns is the middle of cells, the column located on the right side of the middle position may be defined as the opponent card middle position.

[Transverse Movement Step M1]

In an example of the match-up of the present embodiment, a card group of the opponent deck is firstly moved in transversely moving one or more cards. In the card group of the opponent deck, a card placed in the first row on the entire card middle position and cards placed in the first row and on the right side of the entire card middle position are all transversely moved to the cells located immediately on the left side of them. When there is herein other card in a destination cell for a given one of the aforementioned cards, the given card is not moved thereto. When a given card placed in the first row is transversely moved, the other card or cards placed behind and in the same column as the given card is/are also transversely moved in conjunction with the given card.

[Transverse Movement Step M2]

Next, cards of the opponent deck, located in the first row and on the left side of the entire card middle position, are all transversely moved to the cells located immediately on the right side of them. When there is other card in a destination cell for a given one of the aforementioned cards, the given card is not moved thereto. When a given card placed in the first row is transversely moved, the other card or cards placed behind and in the same column as the given card is/are also transversely moved in conjunction with the given card.

[Transverse Movement Step M3]

When transverse movement of cards of the opponent deck is completed, transverse movement is subsequently performed for a card group of the user deck. In the card group of the user deck, a card placed in the first row on the opponent card middle position and cards placed in the first row and on the left side of the opponent card middle position are all transversely moved to the cells located immediately on the right side of them. When there is other card in a destination cell for a given one of the aforementioned cards, the given card is not moved thereto. When a given card placed in the first row is transversely moved, the other card or cards placed behind and in the same column as the given card is/are also transversely moved in conjunction with the given card.

[Transverse Movement Step M4]

Next, cards of the user deck, located in the first row and on the right side of the opponent card middle position, are transversely moved to the cells located immediately on the left side of them. When there is other card in a destination cell for a given one of the aforementioned cards, the given card is not moved thereto. When a given card placed in the first row is transversely moved, the other card or cards placed behind and in the same column as the given card is/are also transversely moved in conjunction with the given card.

In the game of the present embodiment, attack by the card group of the user deck and attack by the card group of the opponent deck are alternately made, and every time attack is made, a series of processing of transversely moving cards in the aforementioned steps M1 to M4 is sequentially performed. Cards are attacked and sequentially disappear during the match-up, and hence, the entire card middle position and the opponent middle position are supposed to be changed every time card disappearance occurs.

It should be noted that as described above, when the middle position between the row of the leftmost cell in which a given card is placed and the row of the rightmost cell in which a given card is placed is the middle between cells, the entire card middle position and the opponent card middle position are configured to be determined as being located on the opposite sides through the aforementioned middle position between the rows (i.e., one of the entire card middle position and the opponent card middle position is set as the row located on the left side of the middle position, whereas the other is set as the row located on the right side of the middle position). Hence, a card of the opponent deck on the entire card middle position and a card of the user deck on the opponent card middle position are configured to be moved to cross in opposite directions. Therefore, the card group of the user deck and that of the opponent deck are likely to be opposed in the aforementioned transverse movement during the match-up.

Next, a specific example of transverse movement of cards will be explained with reference to FIG. 13. A card layout shown in S4 is herein assumed. In this example of card layout, the entire card middle position CL_all is the fourth column. Accordingly, as described in the aforementioned step M1, cards of the opponent deck which has been placed in the first row and the fourth to sixth columns, are all transversely moved to the cells located immediately on the left side of them together with cards placed behind these cards (S5). In S5 of FIG. 13, movement directions of three cards are depicted with arrows. A card placed in a cell Cb(1,3) located on the left side of the entire card middle position CL_all cannot be moved to the right side. Hence, in this example, the aforementioned step M2 is not performed substantially. In the card layout of S5 (a layout produced after movement of three cards), the opponent card middle position CL_opp is the fourth column. Accordingly, next, as described in the aforementioned step M3, cards of the user deck, which are placed in the first row and in the first to fourth columns, are all transversely moved to the cells located immediately on the right side of them together with cards placed behind these cards (S6). In S6 of FIG. 13, movement directions of three cards are depicted with arrows. There is no card placed on the right side of the opponent card middle position CL_opp in the user deck. Hence, in this example, the aforementioned step M4 is not performed substantially.

As described above, in each of the card groups of the user deck and the opponent deck, every time a card placed in the first row disappears, one or more cards placed behind the disappeared card is/are sequentially moved forward, and accordingly, cards located in the same column are shifted forward without producing a gap. Additionally, in each of the card groups of the user deck and the opponent deck, when all the cards in a given column disappear, one or more cards placed in a column adjacent to the given column is/are transversely moved to fill the gap between columns. Based on forward movement and transverse movement described above, each of the card groups of the user deck and the opponent deck is moved on the match-up field during the match-up such that cards are placed adjacently to each other. In other words, the card group of each deck performs an action of integrated movement during the match-up. Hence, a user can feel a sensation as if he/she were in a real match-up.

(1-6-5) Example of Card Movement in Match-up Battle

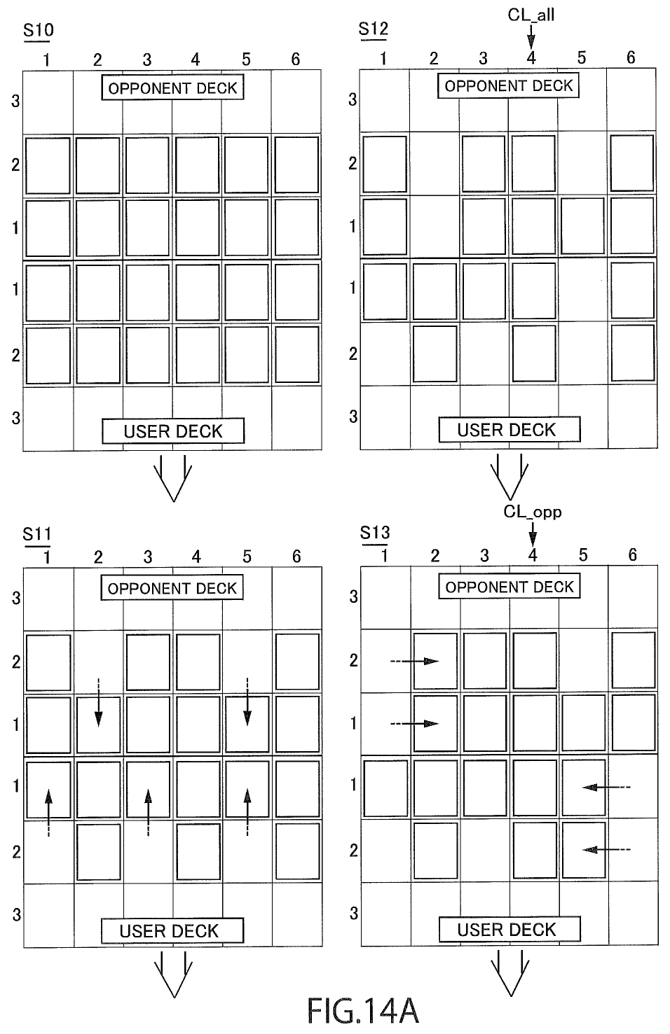

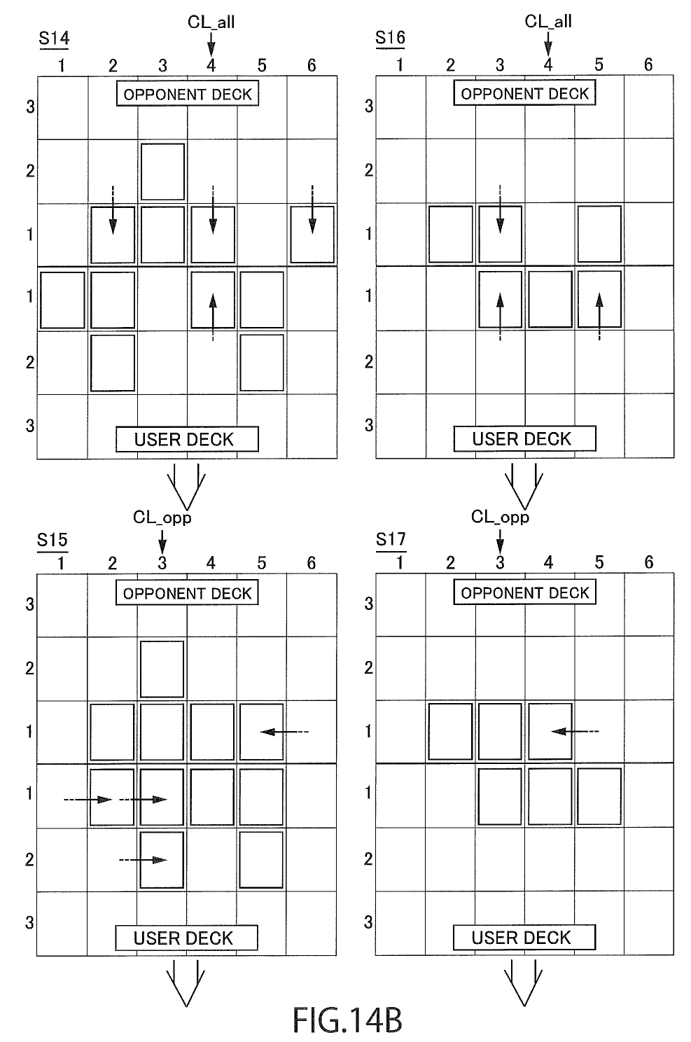

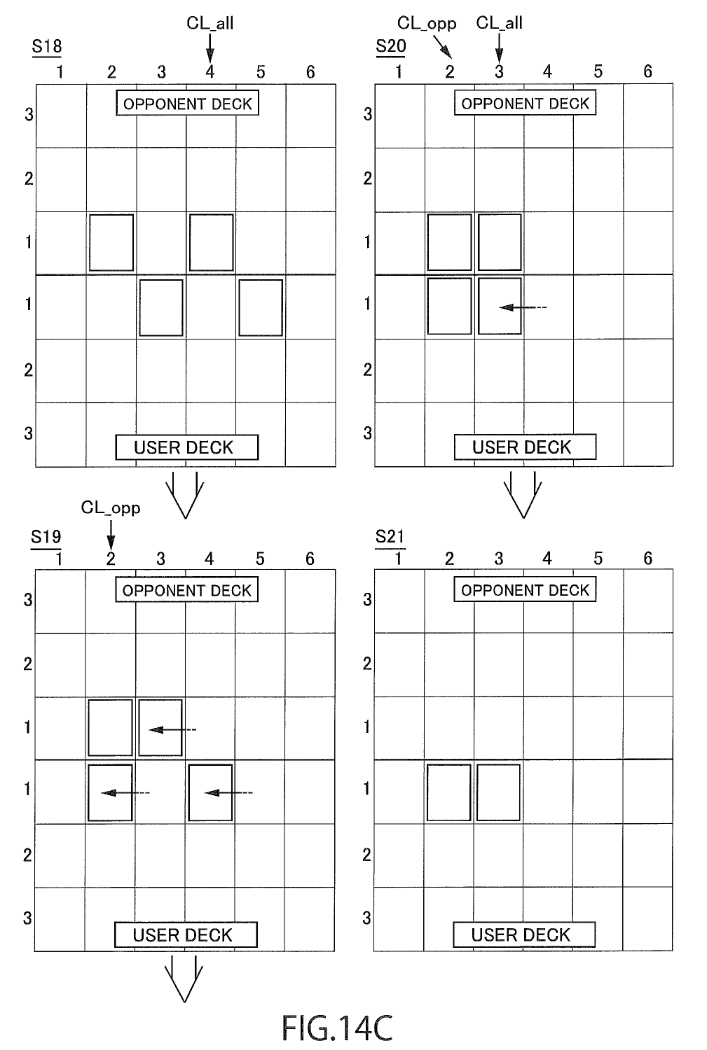

Next, with reference to FIGS. 14A to 14C, explanation will be provided for a specific example of a movement aspect of cards of the user deck and those of the opponent deck from the beginning to the end of a match-up in the game of the present embodiment. FIGS. 14A to 14C are drawings for showing layouts of cards on the respectively cells on the match-up field when the game space is seen in a plan view for explaining the movement aspect of cards from the beginning to the end of the match-up. In each drawing, card movements are depicted with arrows.

For example, in the match-up of the present embodiment, attack by the user deck and attack by the opponent deck are made in turns as described above. After attack by each deck is made, forward movement of cards and transverse movement of cards are sequentially performed on an as-needed basis.

In the match-up shown in FIGS. 14A to 14C, as depicted in S10 of FIG. 14A, an example is shown that 12 cards are placed in each of the region UAa for the user deck composed of 2×6 cells and the region UAb for the opponent deck composed of 2×6 cells.

In the match-up of the present embodiment, attacks are made by the respective decks in turns, and after each attack is made, processing of forward movement and that of transverse movement are respectively performed. In the early stage of the match-up, cards of each deck which is placed in the first row in the beginning of the match-up, are attacked and disappear, and hence, forward movement of cards is subjectively performed as shown in, for instance, S11. S11 shows a condition in which five cards are moved from cells in the second row to those in the first row.

When the match-up progresses and a condition in which no card exists in a given column of each user region occurs as shown in S12, transverse movement of cards is performed. In S12, no card exists in the fifth column of the region UAa for the user deck and in the second column of the region UAb for the opponent deck. In the example of S12, the entire card middle position CL_all is the fourth column. Hence, two cards placed in the first to third columns (cards placed in cells Cb(1,1) and Cb(1,2)) are moved to the cells located immediately on the right side of them. It should be noted that in S12, cards of the opponent deck which has been placed in the fourth to sixth columns cannot be moved to the left side.

As shown in S13, the opponent card middle position CL_opp is the fourth column after two cards of the opponent deck have been moved to the cells located immediately on the right side of them. Accordingly, in S13, two cards of the user deck placed in the fifth and sixth columns (cards placed in cells Ca(1,6) and Ca(2,6)) are moved to the cells located immediately on the left side of them. It should be noted that in S13, cards of the user deck which has been placed in the first to fourth columns, cannot be moved to the right side.

It is herein assumed that as a result of progression of the match-up from the condition of S13, cards placed in the first row have disappeared and forward movement of cards has been performed, and this has resulted in a card layout of S14. In the example of S14, the entire card middle position CL_all is the fourth column. Accordingly, in S15, a single card of the opponent deck placed in the fourth to sixth columns (a card placed in a cell Cb(1,6)) is moved to the cell located immediately on the left side of it. It should be noted that in S15, cards of the opponent deck which has been placed in the second and third columns, cannot be moved to the right side.

As shown in S15, the opponent card middle position CL_opp is the third column after the single card of the opponent deck has been moved to the cell located immediately on the left side of it. Accordingly, in S15, three cards of the user deck placed in the first to third columns in S14 (cards placed in cells Ca(1,1), Ca(1,2) and Ca(2,2)) are moved to the cells located immediately on the right side of them. It should be noted that after this movement, cards of the user deck which is placed in the fourth and fifth columns cannot be moved to the left side.

It is herein assumed that as a result of progression of the match-up from the condition of S15, cards placed in the first row have disappeared and forward movement of cards has been performed, and this has resulted in a card layout of S16. In the example of S16, the entire card middle position CL_all is the fourth column. Accordingly, in S17, a single card of the opponent deck placed in the fourth to sixth columns (a card placed in a cell Cb(1,5)) in S16 is moved to the cell located immediately on the left side of it. It should be noted that after this movement, cards of the opponent deck which is placed in the second and third columns cannot be moved to the right side.

As shown in S17, the opponent card middle position CL_opp is the third column after the single card of the opponent deck has been moved to the cell located immediately on the left side of it. In this case, any cards of the user deck cannot be moved.

It is herein assumed that as a result of progression of the match-up from the condition of S17, the card of the user deck placed in a cell Ca(1,4) and the card of the opponent deck placed in a cell Cb(1,3) have disappeared, and this has resulted in a card layout of S18. In the example of S18, the entire card middle position CL_all is the fourth column. Accordingly, in S19, a single card of the opponent deck which is placed in the fourth column (a card placed in a cell Cb(1,4)) in S18, is moved to the cell located immediately on the left side of it. It should be noted that in S19, after this movement, the card of the opponent deck which has been placed in the second column, cannot be moved to the right side.

As shown in S19, the opponent card middle position CL_opp is the second column after the single card of the opponent deck has been moved to the cell located immediately on the left side of it. In this case, in S19, two cards of the user deck which has been placed in the second to sixth columns in S18 (cards placed in cells Ca(1,3) and Ca(1,5)), are moved to the cells located immediately on the left side of them.

It is herein assumed that any cards have not disappeared as a result of attacks after movement of three cards in S19. In this case, the entire card middle position CL_all is the third column. At this time, as shown in S20, the card of the opponent deck which has been placed in the third column cannot be moved to the left side, and likewise, the card of the opponent deck which has been placed in the second column cannot be moved to the right side. On the other hand, the opponent card middle position CL_opp is the second column. Hence, as shown in S20, a single card of the user deck which has been placed in the fourth column in S19 (a card placed in a cell Ca(1,4)) is moved to the cell located immediately on the left side of it.

It is assumed in S21 that two cards placed in the first row of the region for the opponent deck in S20 have disappeared. In this case, all the cards of the opponent deck have disappeared. In other words, the user deck wins the match-up.

As described in an example of the match-up in FIGS. 14A to 14C, in the match-up of the present embodiment, each of the card groups of the user deck and the opponent deck is moved on the match-up field during the match-up such that cards are placed adjacently to each other. Additionally, in transverse movement of the card group of the user deck and that of the opponent deck, the card group of the opponent deck is firstly transversely moved toward the entire card middle position, and then, the card group of the user deck is transversely moved toward the opponent card middle position. Therefore, in each of attack turns of the respective decks, card position is configured to be adjusted such that the card group of the user deck and that of the opponent deck are faced to each other. Therefore, the card groups of the respective decks are always faced from the beginning to the end of the match-up. Hence, a user can feel a sensation as if he/she were in a more real match-up.

As described above, in the match-up of the present embodiment, the respective cards included in the user deck are configured to be moved in right-and-left and back-and-forth directions in accordance with disappearance of the other cards. Additionally, in the course of movement of each card, attack target cards included in the attack range of each card and values of attack power to be made on the attack target cards from each card are configured to be changed in accordance with the attack range of each card. Therefore, it is still difficult to recognize how each card should be placed and used to make each card effectively work during the match-up (i.e., usability in the match-up) only by separately checking the parameters of each card.

(1-6-6) Drawing with Mock Match-up

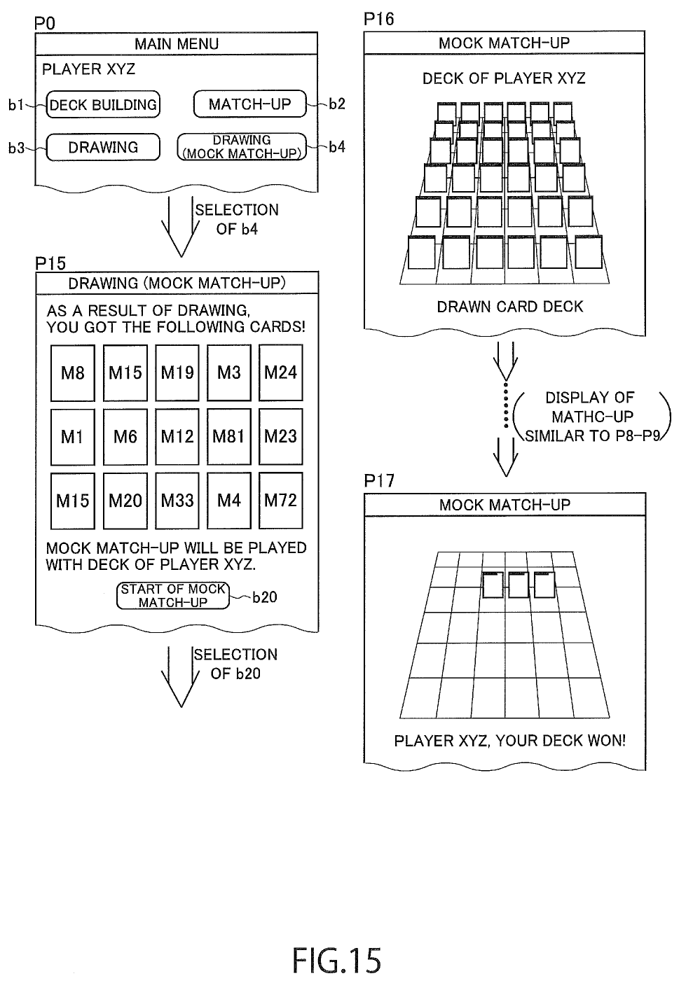

When the button b4 (“drawing (mock match-up”) is selected on the image P0 of FIG. 15, the image is updated as shown in P15. The image P15 shows a predetermined number of cards (here, 15 cards) have been selected by drawing. In the image P15, a button b20 (“start of mock match-up”) is further provided for starting a mock match-up between the user deck of the user XYZ and a drawn card deck composed of a group of cards selected by drawing. When the button b20 is selected, images similar to the images P7 to P10 are displayed as shown in the images P16 and P17.

The reason for providing drawing with a mock match-up is as follows. In short, as described above, the match-up of the game of the present embodiment includes complex match-up elements including frequent movements of cards, variation in attack power in accordance with distance between cards, and so forth. For example, it is difficult for a user to recognize whether or not each drawn card effectively works in an actual match-up only by separately checking the parameters of each drawn card in the image P15 and so forth. Therefore, by building a drawn card deck and playing a mock match-up between the drawn card deck and the user deck to be used for a match-up with other user, the user can easily recognize usability of the respective drawn cards in match-ups and figure out an effective method of utilizing the respective drawn cards in the subsequent match-ups between users and so forth. In other words, the user easily recognizes the ability of the drawn cards by playing the aforementioned mock match-up because the user deck is a type of deck normally used by the user in match-ups and hence the user grasps the actual performance of the user deck in match-ups.

It should be noted that a method of building a drawn card deck based on drawn cards may be arbitrarily set. For example, although not shown in FIG. 15, layout of the respective cards may be configured to be determinable based on an operation of a user similarly to the configuration shown in the images P2 to P4 in FIG. 10. Alternatively, layout of the respective cards may be configured to be automatically determined based on the parameters of the drawn cards. For example, cards with attack range of “SR”, those with attack range of “MR” and those with attack range of “LR” may be respectively placed in the first, second and third rows of the drawn card deck. With this layout, it is possible to build a drawn card deck based on an attack layout in which the drawn cards work well. Accordingly, it is possible to appropriately grasp the ability of each drawn card in the mock match-up. At this time, it is preferable to appropriately set the parameters of cards selected by drawing in accordance with the matrix of a drawing field. For example, as exemplified in FIG. 15, when the match-up field, on which the drawn card deck is built, is a matrix of 3×6 cells, a predetermined number of cards (e.g., six cards) may be configured to be selected by drawing as each of: cards with attack range of “SR”; cards with attack range of “MR”; and cards with attack range of “LR”.

It should be noted that although not described in detail, when the button b3 (“drawing”) is selected on main menu shown in the image P0 of FIG. 15, a predetermined number of cards selected by drawing are displayed similarly to the image P15 of FIG. 15. It should be noted that in this case, the button b20 (“start of mock match-up”) for starting the aforementioned mock match-up is not displayed.

(1-7) Overview of Functions Equipped by Game Control Device

Next, functions equipped by a game control device to implement the aforementioned game of the present embodiment will be explained.

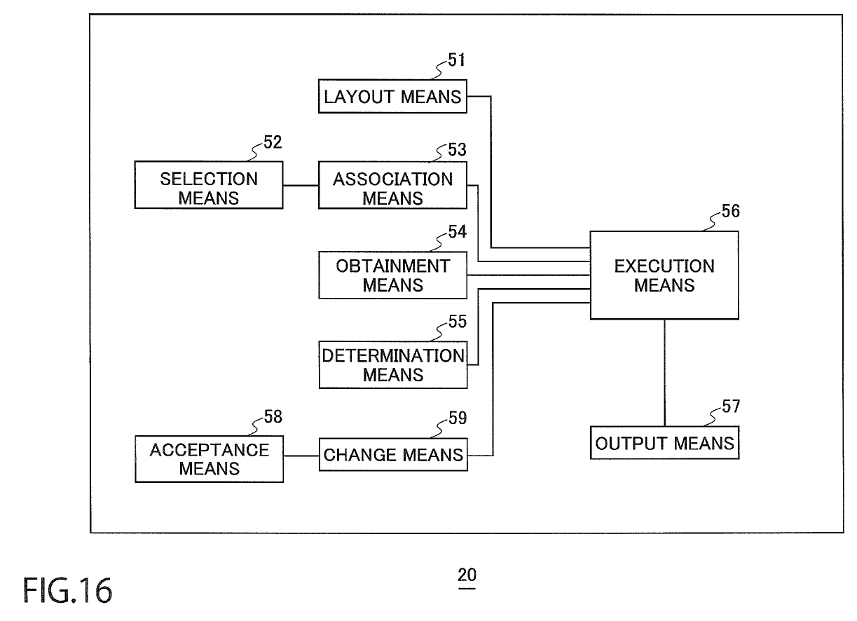

In the present embodiment, the game server 20 is an embodiment of the information processing device. With reference to FIG. 16, functions to be implemented by the game server 20 will be hereinafter explained by exemplifying application of the aforementioned game of the embodiment. FIG. 16 is a functional block diagram for explaining functions to be implemented by the game server 20. It should be noted that not every means described in FIG. 16 is necessarily required. For example, acceptance means 58 and change means 59 will be described in modifications later.

Layout means 51 has a function of creating or editing a user deck to be used by a given user in a match-up based on cards possessed by the user.

To implement the function of the layout means 51, the CPU 21 of the game server 20 is configured to, when obtaining input information by an operation of the user through the communication interface unit 24, perform processing in accordance with the input information, generate image data containing a result of the processing, and send the image data to the user terminal 10 of the user. Accordingly, an image is displayed on the user terminal 10 of the user, or the image displayed on the user terminal 10 is updated. This will be specifically explained as follows.

(I-1) New Card Layout

When the input information of a given user relates to new card layout, this input information contains a result of selecting one of the cards possessed by the user as a new match-up use card and a result of selecting a cell in which the selected card is placed (a region in which the card is placed). When obtaining the input information, the CPU 21 is configured to write data into the attributes Initial-position, Card-ID and Serial-number in the deck data table. It should be noted that values of the attributes Card-ID and Serial-number to be herein written are read out from the possessed card data table of the user.

The input of new card layout by the user corresponds to, for instance, selecting the button b6 (“building of new deck”) in the image P1 or selecting the button b10 (“more card addition”) in the image P4. It should be noted that in the former case, the CPU 21 is configured to create a new deck ID on the deck data table.

(I-2) Change of Card Layout

When the input information of a given user relates to change of card layout, the CPU 21 is configured to update the deck data table based on the input information. The input information contains a given match-up use card that has been already placed by the user and a result of selecting a new possessed card with which the given already placed card is replaced. The CPU 21 is configured to write the values of the attributes Card-ID and Serial-number of the possessed card selected anew by the user into the deck data table such that the values of the attributes Card-ID and Serial-number of the given already placed card are thereby replaced. Accordingly, the positions of the cells in which these cards are placed are configured to be changed.

The input of changing card layout by the user corresponds to, for instance, an input of specifying the button b11 (“replacement of placed card”) in the image P4 in a condition in which any of the cards that have been placed on the matrix 201 is selected.

(I-3) Cancellation of Card Layout

When the input information of a given user relates to cancellation of card layout, the CPU 21 is configured to update the deck data table based on the input information. The input information contains information of a given match-up use card of the user as a layout cancellation target. When obtaining the information of the given match-up use card of the user as the layout cancellation target, the CPU 21 is configured to delete the values of the attributes Card-ID and Serial-number of the given match-up use card from the deck data table.

The input of cancellation of card layout by the user corresponds to, for instance, an input of selecting any of the cards placed on the matrix 201 in the image P4 and an input of specifying the button b12 (“cancellation of placed card”).

Selection means 52 has a function of selecting one or more cards (drawn cards) to be given to a given user by drawing based on an operation by the user. It should be noted that the number of drawn cards is not particularly limited. The drawn card is an example of a second object.

For example, the function of the selection means 52 is implemented as follows. When obtaining a drawing request from a given user terminal 10, the game server 20 is configured to randomly select one or more cards (drawn cards) to be given to the user of the given user terminal 10 from a plurality of cards that are contained in the card data table and are respectively specified by values of the attribute Card-ID. The number of drawn cards is not particularly limited. In the example shown in FIG. 15, when either the button b3 (“drawing”) or the button b4 (“drawing (mock match-up”) is selected, the user terminal 10 is configured to send a drawing request to the game server 20. Additionally, in the example shown in FIG. 15, the number of drawn cards is 15. The CPU 21 of the game server 20 is configured to generate image data containing the one or more drawn cards and send the image data to the user terminal 10.

It should be noted that the data configuration of a drawing request configured to be sent by selecting the button b3 (“drawing”) and that of a drawing request configured to be sent by selecting the button b4 (“drawing (mock match-up)”) can be differentiated by the CPU 21.

Association means 53 has a function of associating one or more drawn cards selected by the selection means 52 with a given user that is a source of the drawing request.

To implement the function of the association means 53, the CPU 21 of the game server 20 is configured to update the possessed card data table of the user such that values of the attributes of the one or more drawn cards can be added thereto. At this time, a value of the attribute Serial-number is configured to be generated for the value of the attribute Card-ID of each drawn card and be written in the possessed card data table. When the values of the attributes Card-ID and Serial-number are written in the possessed card data table in association with the value of the attribute User-ID of a given user, the given user and the one or more drawn cards are configured to be associated.

Obtainment means 54 has a function of obtaining information of a user deck of a given user from the storage 25. The user deck is an example of a first object group.

To implement the function of the obtainment means 54, the CPU 21 of the game server 20 is configured to read out information of the user deck corresponding to any of a plurality of values of the attribute Deck-ID of the given user from the deck data table and to load the information to the RAM 23.

It should be noted that a value of the attribute Deck-ID as a read-out target in a match-up may be configured to be preliminarily determined from a plurality of values of the attribute Deck-ID of the given user, or alternatively, a value of the attribute Deck-ID desired by the given user may be configured to be selected in response to a selection operation by the user in each match-up.

Determination means 55 has a function of determining a layout of one or more drawn cards placed in a mock match-up based on the value of the attribute Attack-range of each drawn card and then building a drawn card deck based on the determined layout. The attribute Attack-range is an example of layout information. It should be noted that in the present embodiment, the determination means 55 is not indispensable means, and each drawn card may be placed regardless of the value of the attribute Attack-range.

As described above, the attribute Attack-range is defined as a parameter indicating the attack range of a given card, in which the given card performs best in attack. The value of the attribute Attack-range is any of “SR” (short range), “MR” (middle range) and “LR” (long range).

To implement the function of the determination means 55, the CPU 21 of the game server 20 is configured to read out values of the attributes Card-name, Card-image and Card-parameters of each drawn card from the card data table and create data of a drawn card deck composed of drawn cards in the RAM 23. Data of the drawn card deck is structured similarly to the data of each deck ID in the deck data table exemplified in FIG. 8. At this time, in determining drawn cards to be placed in initial positions, values of the attribute Attack-range of the drawn cards are referred.

In a preferred example, drawn cards with “SR” as the value of the attribute Attack-range are placed in the first row (X=1), those with “MR” as the value of the attribute Attack-range are placed in the second row (X=2), and those with “LR” as the value of the attribute Attack-range are placed in the third row (X=3). By thus placing the drawn cards, a mock match-up is configured to be played in a condition in which the drawn cards are respectively placed so as to perform best in attack. Therefore, the drawn cards are configured to be placed in positions that they are likely to achieve the actual performance thereof in a mock match-up, and this enables a given user to more reliably judge whether or not the drawn cards can be effectively utilized.

Additionally, by building a drawn card deck based on values of the attribute Attack-range of drawn cards, it is possible to implement a tutorial function of showing the given user a position where each drawn card performs best in attack.

Execution means 56 has a function of executing a match-up between user decks of different users, a match-up between a user deck of a user and an NPC, and a match-up between a user deck and a drawn card deck.

A match-up between a user deck and an opponent deck will be hereinafter explained. The opponent deck corresponds to a drawn card deck in a mock match-up.

To implement the function of the execution means 56, the CPU 21 of the game server 20 is configured to create and record match-up processing data in the RAM 23 on an as-needed basis as an execution result of a match-up processing (including an attack processing, an HP update processing, a card disappearance processing and a card movement processing, which are to be described). The CPU 21 is configured to create a reproducible file (an example of image data) for playing scenes from the beginning to the end of a match-up based on a series of match-up processing data during the match-up. The file format of the reproducible file is not particularly limited and, for instance, may be SWF.

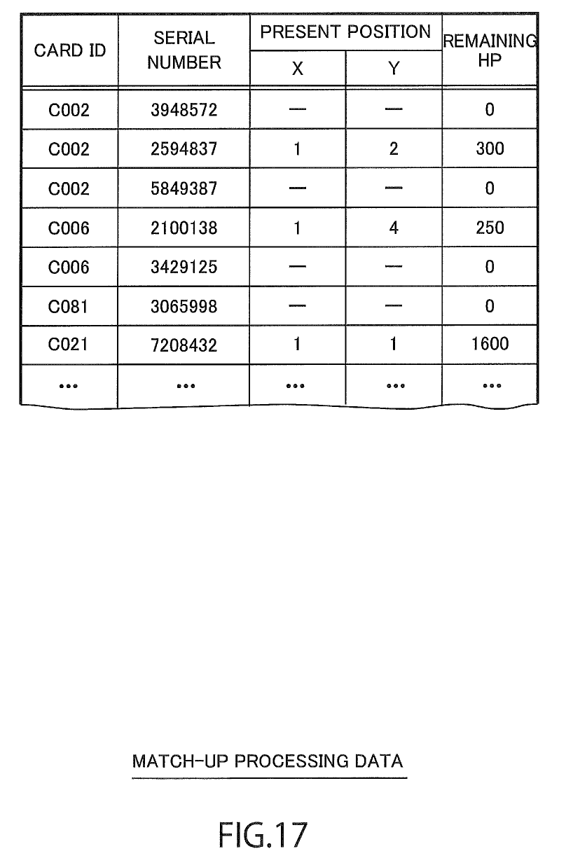

FIG. 17 is a diagram showing an example of a data configuration of match-up processing data. The match-up processing data exemplified in FIG. 17 shows only one of the both card decks playing a match-up. However, the match-up processing data is configured to be created for each of the both card decks during a match-up. The match-up processing data contains data of an attribute Present-position defined as a present position on a match-up field and an attribute Remaining-HP (indicating “the remaining amount of HP”) in association with each match-up use card (values of the attributes Card-ID and Serial-number) included in each of the card decks playing a match-up. The match-up processing data is configured to be created and recorded every time any of the following situations occurs: the value of the attribute Remaining-HP of any of the match-up use cards is changed; values of the attribute Present-position are changed; and any of the match-up use cards disappears.

The match-up processing will be hereinafter specifically explained.

(A) Attack Processing

In the attack processing included in the match-up processing, a user deck and an opponent deck are configured to alternately attack against each other. In an attack turn of each deck, each match-up use card is configured to attack one or more cards of the opponent deck. Which of the cards of the opponent deck become one or more attack targets in attack by a given card is configured to be determined based on the value of the attribute Attack-range of the given card in the card data table. The direction of attack by the given card can be arbitrarily set, but is preferably set to be the forward direction or a direction close to the forward direction from the cell in which the given card is placed at the time of attack. For example, attack by the given card is configured to be made on a card of the match-up opponent placed in the same column as or in a column adjacent to the cell in which the given card is placed.

The direction of attack by a given card is as described above, and on the other hand, the distance from an attacker card to an attack target card may be set from the following perspectives. In short, when a given card in one of the decks attacks, one of the opponent cards may be preferentially set as an attack target when placed within a range corresponding to the value of the attribute Attack-range of the given card in the card data table and is also placed foremost (a card placed nearest to the given card, such as a card placed in the first row). In this case, when the attack target card disappears, this promotes forward movement of one or more cards placed rearward of the attack target card. Hence, forward movement of the entire cards is promoted, and the match-up becomes more dynamic.

Additionally, a user may be allowed to specify the direction of attack by the given card and to specify which row should be prioritized as the row of the attack target card.

When card layout is completed for the user deck, the CPU 21 of the game server 20 is configured to load data of the respective match-up use cards in each of the user deck and the opponent deck in the card data table to the RAM 23 and then execute the attack processing in an attack turn of the user deck and that of the opponent deck as follows.

The CPU 21 is configured to execute the attack processing of the user deck in the attack turn of the user deck. In the attack processing of the user deck, it is determined whether or not each card of the user deck has reached attack timing. When it is determined that a given card has not reached the attack timing, the CPU 21 is configured not to execute the attack processing of the given card. When it is determined that the given card has reached the attack timing, the CPU 21 is configured to execute the attack processing of the given card.

In the attack processing of the given card, the CPU 21 is configured to determine which of the cards of the opponent deck should be one or more attack targets of the given card. In the opponent deck, one or more cards may be all set as attack targets when placed within the attack range of an attacker card from the cell in which the attacker card is placed. In this case, with reference to the match-up processing data of the opponent deck, the CPU 21 is configured to specify which of the cards of the opponent deck are placed within the attack range of the attacker card from the cell in which the attacker card is placed. The CPU 21 may be configured to set all the specified cards of the opponent deck as attack targets, or alternatively, may be configured to select part of the specified cards of the opponent deck in accordance with a predetermined condition or in a random manner and determine the selected card/cards as the attack target/targets. Preferably, the CPU 21 is configured to specify which card/cards is/are placed within the attack range of the attacker card from the cell in which the attacker card is placed among the opponent deck cards that are placed in the same column as the cell in which the attacker card is placed and in one or more columns adjacent to the cell in which the attacker card is placed.

The attack processing of the opponent deck in the attack turn of the opponent deck is similar to the aforementioned attack processing of the user deck. Hence, repeated explanation for the same content (s) will be avoided.

(B) HP Update Processing

The match-up processing includes a processing of updating the value of the attribute HP of at least any of the cards included in the card group of either the user deck or the opponent deck based on the match-up use cards of either of users in a match-up between the user deck and the opponent deck.

For example, the HP update processing in an attack turn of the user deck will be explained as follows.

When one or more cards of the opponent deck are specified as one or more targets to be attacked by each card of the user deck in an attack turn of the user deck, the CPU 21 of the game server 20 is configured to execute a processing of reducing the value of the attribute HP of each specified card. A reduction amount AHP of the value of the attribute HP of each attacked card of the opponent deck is configured to be determined based on the parameters of each attacked card and the parameters of a given attacker card.

At this time, the CPU 21 is configured to determine one or more cards of the opponent deck as one or more attack targets (attack target cards) and determine the value of the attribute Attack-power to be made on each attack target card based on the values of the attributes Attack-range, Attack-power and Hit-accuracy as parameters associated with the given attacker card. In other words, the CPU 21 is configured to specify one or more cards of the opponent deck which are placed within a predetermined distance from the attacker card, as one or more attack target cards and determine the value of the attribute Attack-power to be made on each attack target card based on the value of the attribute Attack-range of the given attacker card and the distance between the given attacker card and each attack target card. When the value of the attribute Attack-power to be made on each attack target card is determined, the CPU 21 is configured to determine the reduction amount of the value of the attribute HP of each attack target card based on the values of the attributes Defense-power and Avoidance-skill as parameters associated with each attack target card. With increase in value of the attribute Avoidance-skill of each attack target card, each attack target card is set to avoid attack (i.e., the reduction amount of the value of the attribute HP becomes zero) at a higher probability. With increase in value of the attribute Defense-power of each attack target card, the reduction amount of the value of the attribute HP of each attack target card is regulated to be lesser with respect to the same magnitude of attack.

The HP update processing has been explained for an attack turn of the user deck, but this is also true of an attack turn of the opponent deck.

For example, impact to be made by the value of the attribute Attack-range of a given card in attack may be adjusted as follows.

A card with C001 as the value of the attribute Card-ID (card C001) shown in FIG. 6 is associated with “200” and “SR” as the values of the attributes Attack-power and Attack-range respectively. In a condition in which this card becomes an attacker card, when the distance between this card and a given attack target card corresponds to one cell (i.e., the both cards are placed in adjacent cells), this is the distance that the card C001 performs best in attack (i.e., short attack range). Therefore, the value of the attribute Attack-power to be made on the given attack target card is set to be “200”. Additionally, when the distance between this card and the given attack target card corresponds to two cells, the value of the attribute Attack-power is set to be “100”. Moreover, when the distance between this card and the given attack target card corresponds to three cells, the value of the attribute Attack-power is set to be “50”. In this way, the value of the attribute Attack-power to be made on the given attack target card is configured to be changed with increase in deviation of the given attack target card from the distance in which the card C001 performs best in attack.

Similarly, when the value of the attribute Attack-range of a given attacker card is “MR”, the attacker card is configured to attack a given attack target card placed at a middle distance from the attacker card with maximum attack power (the value of the attribute Attack-power shown in FIG. 6) and is also configured to attack a given attack target card placed at a distance shorter or longer than the middle distance with a value of the attribute Attack-power smaller than that shown in FIG. 6.

(C) Card Disappearance Processing

The match-up processing includes the card disappearance processing for making a given card disappear from the match-up field when the value of the attribute Remaining-HP of the given card becomes a predetermined value (e.g., zero) or less.

When it is determined that the value of the attribute Remaining-HP of a given card, which is recorded in the match-up processing data, has become a predetermined value or less, the CPU 21 of the game server 20 is configured to execute a processing of nullifying data of the attribute Present-position of the given card in the match-up processing data. Accordingly, when a reproducible file is reproduced, the given card is configured to disappear from the point of time that the value of the attribute Remaining-HP of the given card becomes the predetermined value or less.

(D) Card Movement Processing

The match-up processing includes the card movement processing for moving the card group in each deck within the match-up field in a match-up between the user deck and the opponent deck such that cards included in each deck are placed adjacently to each other.

In the card movement processing, when a given card disappears during the match-up, the card groups of the user deck and the opponent deck, remaining without disappearing, are configured to be moved within the match-up field such that cards in each deck are placed adjacently to each other. The movement aspect is not particularly limited, but the present embodiment exemplifies an aspect in which forward movement and transverse movement are performed for each card group such that cards in each card group are placed adjacently to each other. At this time, forward movement is preferably performed in priority to transverse movement.

Hereinafter, (II-1) forward movement processing and (II-2) transverse movement processing will be explained in this order.

(II-1) Forward Movement Processing

When it is determined that a given card located in the first row disappears in the card group of either the user deck or the opponent deck, the CPU 21 of the game server 20 is configured to create the match-up processing data such that one or more cards placed behind and in the same column as the disappeared card are moved forward. In other words, the CPU 21 is configured to create the match-up processing data so as to update data of the attribute Present-position of the one or more cards to be forwardly moved.

(II-2) Transverse Movement Processing

[Transverse Movement Processing for Cards in Opponent Deck]

The CPU 21 is configured to determine the entire card middle position (CL_all) that is the column on the matrix and indicates the middle position of the card groups in the entire field. Here, the entire card middle position is defined as the column located in the middle of the column of the leftmost cell in which a card is placed and the column of the rightmost cell in which a card is plated on the match-up field. When the middle position between columns is the middle of cells, the column located on the right side of the middle position is defined as the entire card middle position.

When determining the entire card middle position, the CPU 21 is configured to determine the order of processing the respective cards of the card group of the opponent deck. The processing is executed in the following preferential order of (a-1) to (a-4):

(a-1) a left-to-right order starting from the card placed in the entire card middle position regarding one or more cards placed in the first row;

(a-2) a left-to-right order starting from the card placed in the entire card middle position regarding one or more cards placed in the respective rows other than the first row;

(a-3) a right-to-left order regarding one or more cards placed leftward of the entire card middle position in the first row; and

(a-4) a right-to-left order regarding one or more cards placed leftward of the entire card middle position in the respective rows other than the first row.

The CPU 21 is configured to create the match-up processing data such that one or more cards are transversely moved to the left side cell or cells thereof in the order of cards shown in (a-1). In other words, the CPU 21 is configured to create the match-up processing data so as to update data of the attribute Present-position of each of the one or more cards to be transversely moved. When there is herein other card in the destination cell for a given one of the one or more cards to be transversely moved, the given card is not moved thereto.

In executing the transverse movement processing for each of one or more cards in the order of cards shown in (a-2), the CPU 21 is configured to create the match-up processing data such that the one or more cards are moved in conjunction with a result of movement of the one or more cards that had been placed in the same column as the one or more cards to be herein moved and were then moved in the order of cards shown in (a-1). In other words, the CPU 21 is configured to create the match-up processing data so as to update data of the attribute Present-position of each of the one or more cards to be herein moved.

The CPU 21 is configured to create the match-up processing data such that one or more cards are transversely moved to the right side cell or cells thereof in the order of cards shown in (a-3). In other words, the CPU 21 is configured to create the match-up processing data so as to update data of the attribute Present-position of each of the one or more cards to be transversely moved. When there is herein other card in the destination cell for a given one of the one or more cards to be transversely moved, the given card is not moved thereto.

In executing the transverse movement processing for one or more cards in the order of cards shown in (a-4), the CPU 21 is configured to create the match-up processing data such that the one or more cards are moved in conjunction with a result of movement of the one or more cards that had been placed in the same column as the one or more cards to be herein moved and were then moved in the order of cards shown in (a-3). In other words, the CPU 21 is configured to create the match-up processing data so as to update data of the attribute Present-position of each of the one or more cards to be herein moved.

[Transverse Movement Processing for Cards in User Deck]

When the transverse movement processing for cards of the opponent deck is completed, the CPU 21 is configured to execute a transverse movement processing for the card group of the user deck.

The CPU 21 is configured to determine the opponent card middle position (CL_opp) that is the column on the matrix and indicates the middle position of the card group of the opponent deck. Here, the opponent card middle position is the column located in the middle of the column of the leftmost cell in which a card is placed and the column of the rightmost cell in which a cards is placed in the region for the opponent deck. When the middle position between columns is the middle of cells, the column located on the left side of the middle position is defined as the opponent card middle position.

When determining the opponent card middle position, the CPU 21 is configured to determine the order of processing the respective cards of the card group of the user deck. The processing is executed in the following preferential order of (b-1) to (b-4):

(b-1) a right-to-left order starting from the card placed in the opponent card middle position regarding one or more cards placed in the first row;

(b-2) a right-to-left order starting from the card placed in the opponent card middle position regarding one or more cards placed in the respective rows other than the first row;

(b-3) a left-to-right order regarding one or more cards placed rightward of the opponent card middle position in the first row; and

(b-4) a left-to-right order regarding one or more cards placed rightward of the opponent card middle position in the respective rows other than the first row.

The CPU 21 is configured to create the match-up processing data such that one or more cards are transversely moved to the right side cell or cells thereof in the order of cards shown in (b-1). In other words, the CPU 21 is configured to create the match-up processing data so as to update data of the attribute Present-position of each of the one or more cards to be transversely moved. When there is herein other card in the destination cell for a given one of the one or more cards to be transversely moved, the given card is not moved thereto.

In executing the transverse movement processing for one or more cards in the order of cards shown in (b-2), the CPU 21 is configured to create the match-up processing data such that the one or more cards are moved in conjunction with a result of movement of the one or more cards that had been placed in the same column as the one or more cards to be herein moved and were then moved in the order of cards shown in (b-1). In other words, the CPU 21 is configured to create the match-up processing data so as to update data of the present position of each of the one or more cards to be herein moved.

The CPU 21 is configured to create the match-up processing data such that one or more cards are transversely moved to the left side cell or cells in the order of cards shown in (b-3). In other words, the CPU 21 is configured to create the match-up processing data so as to update data of the attribute Present-position of each of the one or more cards to be transversely moved. When there is herein other card in the destination cell for a given one of the one or more cards to be moved, the given card is not moved thereto.

In executing the transverse movement processing for one or more cards in the order of cards shown in (b-4), the CPU 21 is configured to create the match-up processing data such that the one or more cards are moved in conjunction with a result of movement of the one or more cards that had been placed in the same column as the one or more cards to be herein moved and were then moved in the order of cards shown in (b-3). In other words, the CPU 21 is configured to create the match-up processing data so as to update data of the attribute Present-position of each of the one or more cards to be herein moved.

Output means 57 has a function of outputting a reproducible file containing the content of a match-up with the match-up processing data of this match-up by the execution means 56.

When the match-up is a mock match-up, the output means 57 has a function of outputting a reproducible file that is obtained by the obtainment means 54 and contains the content of a match-up between a user deck and a drawn card deck. The reproducible file is an example of output data for making a user recognize the content of a match-up. The aforementioned match-up processing data is an example of information to be obtained as a result of processing of a match-up.

To implement the function of the output means 57 in outputting a reproducible file of a mock match-up, the CPU 21 of the game server 20 is configured to create a reproducible file regarding the content of a mock match-up played by a user between a user deck and a drawn card deck and to send the reproducible file to the user terminal 10 of the user. When receiving the reproducible file, the CPU 11 of the user terminal 10 is configured to play the reproducible file and cause the display unit 16 to display the content of the mock match-up. This enables the user to visually recognize the content of the mock match-up.

(1-8) Flow of Match-up Processing of Present Embodiment

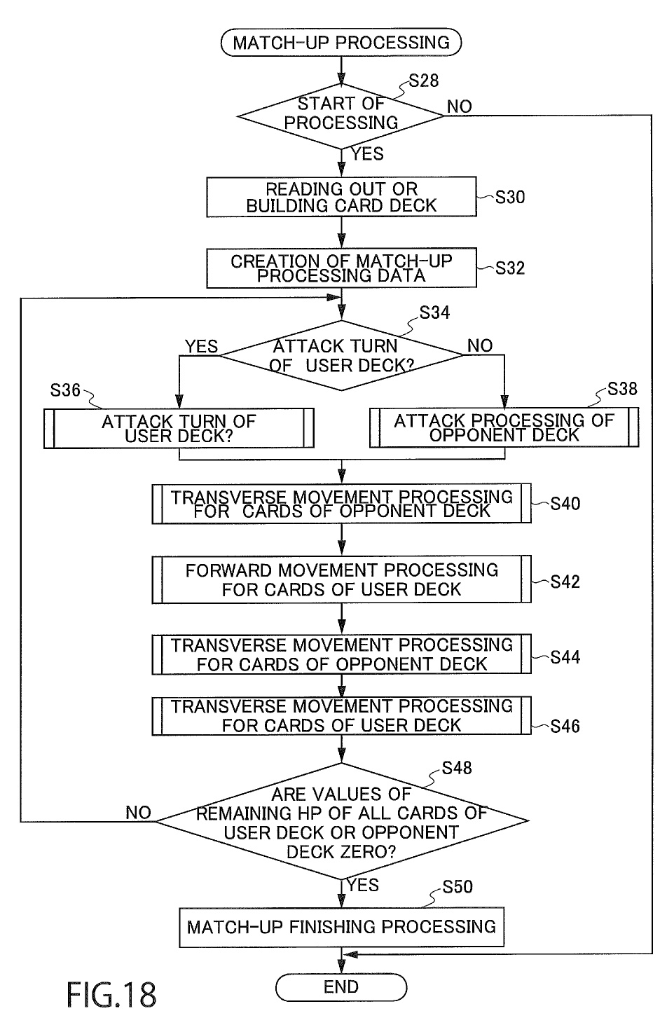

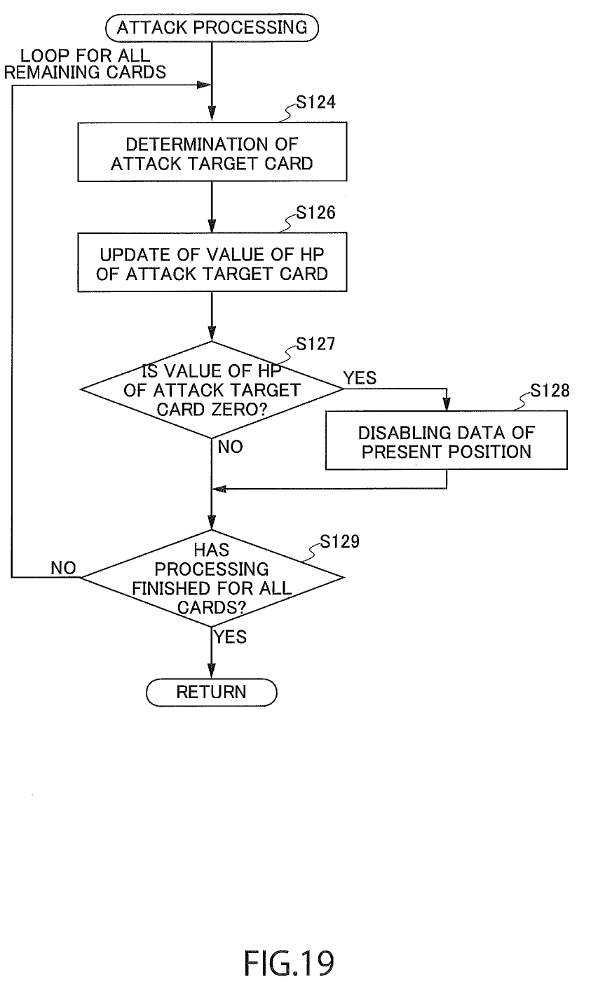

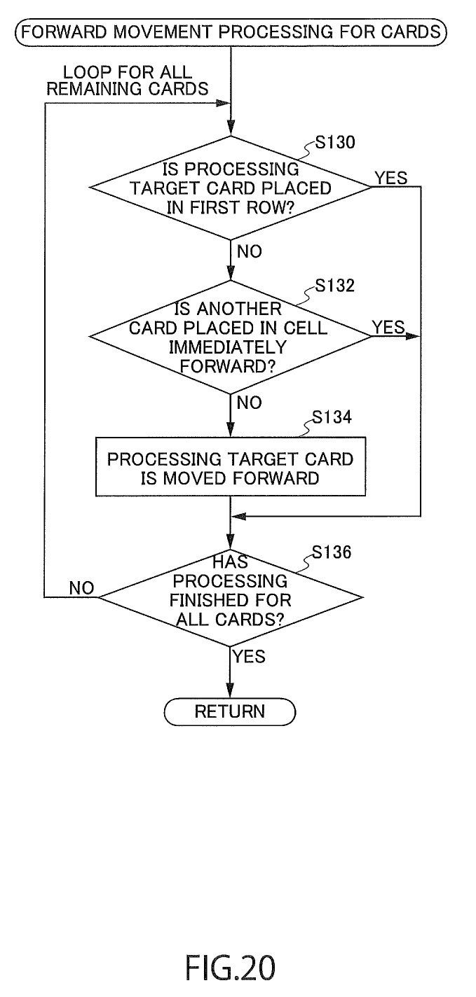

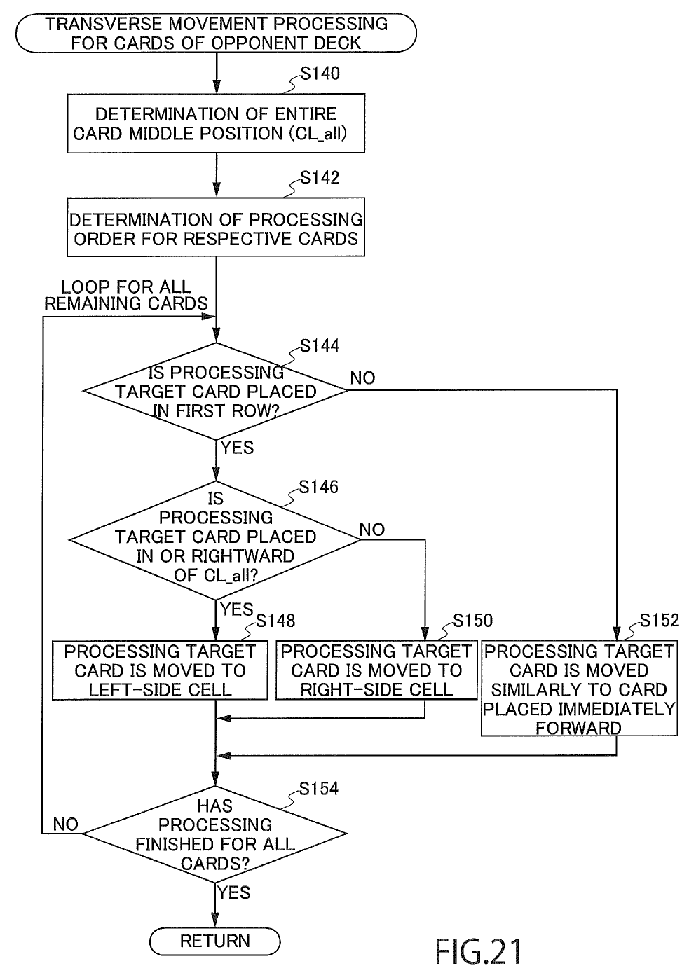

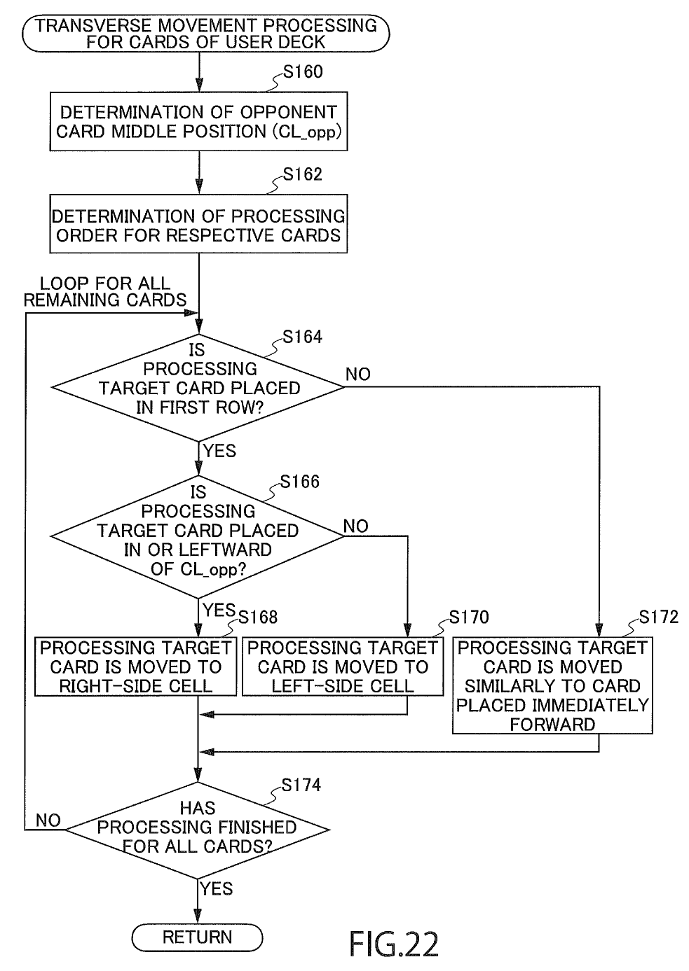

Next, an example of the flow of the match-up processing of the present embodiment will be explained with reference to flowcharts of FIGS. 18 to 22. FIG. 18 is a flowchart showing an example of the card layout processing. FIG. 19 is a flowchart showing an example of the attack processing. FIG. 20 is a flowchart showing an example of the forward movement processing for cards. FIG. 21 is a flowchart showing an example of the transverse movement processing for cards of an opponent deck. FIG. 22 is a flowchart showing an example of the transverse movement processing for cards of a user deck.

It should be noted that the same processing as the following match-up processing is configured to be executed similarly in a mock match-up. In this case, the opponent deck is replaced by a drawn card deck.

(1-8-1) Entire Flow of Match-up Processing (FIG. 18)

In FIG. 18, when receiving an instruction to start a match-up from a user (YES in S28), the CPU 21 of the game server 20 is configured to execute processing steps in and after S30. When not receiving the instruction to start the match-up (NO in S28), the CPU 21 of the game server 20 finishes the match-up processing. It should be noted that the CPU 21 is configured to recognize the instruction to start a match-up by, for instance, obtaining an operational input to select the button b15 in FIG. 11A.

When receiving the instruction to start a match-up, the CPU 21 is configured to, if the match-up is played between users, read out the card decks of the both users from the deck data table (S30) and create the match-up processing data of the initial state based on the data of the card decks (S32). When the match-up is a mock match-up, a drawn card deck may be built by randomly assigning initial positions to drawn cards, or alternatively, may be built as described above by determining the initial positions to be assigned to the respective drawn cards based on the values of the attribute Attack-range of the respective drawn cards. When the drawn card deck is built, the match-up processing data is configured to be created. In a case in which the match-up is a mock match-up, the drawn card deck corresponds to the opponent deck in the following explanation.

The CPU 21 proceeds to S34 after executing the card layout processing for each of the user deck and the opponent deck. In the match-up game of the present embodiment, the attack processing is configured to be executed such that attack by the user deck and attack by the opponent deck are alternately made. Therefore, when determining that the user deck is in an attack turn (YES in S34), the CPU 21 is configured to execute the attack processing of the user deck (S36 and FIG. 19). When determining that the opponent deck is in an attack turn (NO in S34), the CPU 21 is configured to execute the attack processing of the opponent deck (S38 and FIG. 19).

The CPU 21 is configured to execute the movement processing for cards in each of the opponent deck and the user deck after executing the attack processing of either the user deck or the opponent deck. In other words, the CPU 21 is configured to sequentially execute the forward movement processing for cards of the opponent deck (S40 and FIG. 20), the forward movement processing for cards of the user deck (S42 and FIG. 20), the transverse movement processing for cards of the opponent deck (S44 and FIG. 21) and the transverse movement processing for cards of the user deck (S46 and FIG. 22). These processing will be described below with reference to FIGS. 20 to 22.

When determining that all the cards of the user deck or the opponent deck have disappeared (i.e., the values of the attribute Remaining-HP of all the cards have become zero) after the series of processing in S40 to S46 (YES in S48), the CPU 21 is configured to execute the match-up finishing processing (S50) and then finishes the match-up processing. The match-up finishing processing includes creation of a reproducible file based on a series of match-up processing data created by the CPU 21, creation of HTML data containing the reproducible file, sending the HTML data to the user terminal 10 of each user currently playing the match-up, and so forth.

When determining that all the cards of the user deck or the opponent deck have not disappeared yet after the series of processing in S40 to S46 (NO in S48), the CPU 21 is configured to return to S34 and continue the processing of the match-up.

It should be noted that the flowchart of FIG. 18 exemplifies a case in which the attack processing of the user deck (S36) and the attack processing of the opponent deck (S38) are configured to be alternately executed and the movement processing for cards is configured to be executed after each attack processing. However, the configuration of executing the movement processing for cards is not limited to this. The movement processing for cards may be configured to be executed after S36 and S38 are consecutively executed.

(1-8-2) Attack Processing (FIG. 19)

The attack turn of the user deck (S36 in FIG. 18) will be hereinafter explained, but this explanation is also true of the attack turn of the opponent deck (S38 in FIG. 18).

In the attack turn of the user deck, the CPU 21 of the game server 20 is configured to sequentially specify a card to be processed in the respective match-up use cards of the user deck and execute processing steps in S124 to S129.

First, the CPU 21 is configured to determine one or more attack target cards for a processing target card (attacker card) (S124). For example, the CPU 21 may be configured to determine all of one or more of the cards of the opponent deck which is placed within a predetermined range from the position of the attacker card, as the attack target card or cards, or alternatively, may be configured to select one or more of the cards of the opponent deck which is placed within the predetermined range, in accordance with a predetermined condition or in a random manner and determine the selected card or cards as attack target card or cards.

Next, the CPU 21 is configured to execute the processing of updating (specifically, reducing) the value of the attribute HP of each attack target card. As described above, the CPU 21 is configured to determine the reduction amount of the value of the attribute HP of each attack target card based on the values of the parameters of each attack target card and those of the parameters of the card having made attack (i.e., processing target card). The CPU 21 is configured to update the value of the attribute HP of each attack target card based on the calculated reduction amount of the value of the attribute HP (S126). When determining that the value of the attribute Remaining-HP of each attack target card has become zero (YES in S127), the CPU 21 is configured to create the match-up processing data such that the data of the attribute Present-position of each attack target card is nullified (S128). When determining that the value of the attribute Remaining-HP of each attack target card is greater than zero (NO in S127), the CPU 21 proceeds to S129.

When all the cards of the user deck have not been processed yet (NO in S129), the CPU 21 is configured to return to S124 and execute the processing for the next processing target card. When all the cards of the user deck have been processed (YES in S129), the attack turn of the user deck is configured to be finished.

(1-8-3) Forward Movement Processing for Cards (FIG. 20)

The forward movement processing for cards of the user deck will be hereinafter explained, but this explanation is also true of the forward movement processing for cards of the opponent deck.

The CPU 21 of the game server 20 is configured to execute the processing shown in FIG. 20 for the respective cards of the user deck. First, the CPU 21 is configured to determine whether or not there is any processing target card in the first row (S130). When there is any processing target card in the first row (YES in S130), the card or cards cannot be moved forward, and therefore, the CPU 21 is configured to proceed to S136. When all the cards of the user deck have not been processed yet (NO in S136), the CPU 21 is configured to return to S130 for processing the next card.

When there is no processing target card in the first row (NO in S130), the CPU 21 proceeds to S132. When other card of the user deck is not placed in the cell immediately forward of the cell in which the processing target card is placed (NO in S132), the CPU 21 is configured to determine to forwardly move the processing target card (S134). At this time, the CPU 21 is configured to create the match-up processing data so as to update data of the attribute Present-position of the card to be forwardly moved. When other card of the user deck is placed in the cell immediately forward of the cell in which the processing target card is placed (YES in S132), the processing target card cannot be forwardly moved. Therefore, the CPU 21 is configured not to execute the processing of S134.

When all the cards of the user deck have been processed (YES in S136), the forward movement processing for cards of the user deck is configured to be finished.

(1-8-4) Transverse Movement Processing for Cards of Opponent Deck (FIG. 21)

The CPU 21 of the game server 20 is configured to determine the entire card middle position (CL_all) that is the column on the matrix and indicates the middle position of the card groups in the entire field (S140). As described above, the entire card middle position is the column located in the middle of the column of the leftmost cell in which a card is placed and the column of the rightmost cell in which a card is plated on the match-up field. When the middle position between columns is the middle of cells, the column located on the right side of the middle position is defined as the entire card middle position.

After determining the entire card middle position, the CPU 21 is configured to determine the order of processing the respective cards of the card group of the opponent deck (S142). As described above, the processing is executed in the following preferential order of (a-1) to (a-4). After determining the order of processing the respective cards is determined, a series of processing steps in S144 to S154 are configured to be executed for the respective cards in accordance with the processing order:

(a-1) a left-to-right order starting from the card placed in the entire card middle position regarding one or more cards placed in the first row;

(a-2) a left-to-right order starting from the card placed in the entire card middle position regarding one or more cards placed in the respective rows other than the first row;

(a-3) a right-to-left order regarding one or more cards placed leftward of the entire card middle position in the first row; and

(a-4) a right-to-left order regarding one or more cards placed leftward of the entire card middle position in the respective rows other than the first row.

As long as the processing target card is a card to be processed in the aforementioned (a-1), the processing target card is placed in the first row (YES in S144) and is placed in or rightward of the entire card middle position CL_all (YES in S146). Hence, the CPU 21 is configured to execute the processing of moving the processing target card to the cell located on the left side thereof (S148). It should be noted that when there is herein other card in a destination cell for the processing target card, the processing target card is not moved thereto. In S148, the CPU 21 is configured to create the match-up processing data so as to update data of the attribute Present-position of the card to be moved. After completion of the processing of S148, when all the cards of the opponent deck have not been processed yet (NO in S154), the CPU 21 is configured to return to S144 for processing the next card.

As long as the processing target card is a card to be processed in the aforementioned (a-2), the processing target card is not placed in the first row (NO in S144). Hence, the CPU 21 is configured to execute the processing of moving the processing target card (S152) similarly to (i.e., in conjunction with) the processing of moving the card that has been placed in the cell located immediately forward of the processing target card on the match-up field in the beginning of the processing in FIG. 21. In other words, in a case in which the processing target card is a card placed in the cell located in the second or subsequent rows, the processing target card is configured to be moved similarly to the movement aspect that has been already executed for the card to be processed in the aforementioned (a-1). In S152, the CPU 21 is configured to create the match-up processing data so as to update data of the attribute Present-position of the card to be herein moved. After completion of the processing of S152, when all the cards of the opponent deck have not been processed yet (NO in S154), the CPU 21 is configured to return to S144 for processing the next card.

As long as the processing target card is a card to be processed in the aforementioned (a-3), the processing target card is placed in the first row (YES in S144) and is placed in or leftward of the entire card middle position CL_all (NO in S146). Hence, the CPU 21 is configured to execute the processing of moving the processing target card to the cell located on the right side thereof (S150). It should be noted that when there is herein other card in a destination cell for the processing target card, the processing target card is not moved thereto. In S150, the CPU 21 is configured to create the match-up processing data so as to update data of the attribute Present-position of the card to be herein moved. After completion of the processing of S150, when all the cards of the opponent deck have not been processed yet (NO in S154), the CPU 21 is configured to return to S144 for processing the next card.

As long as the processing target card is a card to be processed in the aforementioned (a-4), the processing target card is not placed in the first row (NO in S144). Hence, the CPU 21 is configured to execute the processing of moving the processing target card (S152) similarly to (i.e., in conjunction with) the processing of moving the card that has been placed in the cell located immediately forward of the processing target card on the match-up field in the beginning of the processing in FIG. 21 (S153). In other words, when the processing target card is a card placed in the cell located in the second or subsequent rows, the processing target card is configured to be moved in the similar way that has been already executed for the card to be processed in the aforementioned (a-3). In S152, the CPU 21 is configured to create the match-up processing data so as to update data of the attribute Present-position of the card to be herein moved. After completion of the processing of S152, when all the cards of the opponent deck have not been processed yet (NO in S154), the CPU 21 is configured to return to S144 for processing the next card.

Completion of processing of the last one of the processing target cards to be processed in the aforementioned (a-4) means that the processing of transversely moving all the cards of the opponent deck has been completed (YES in S154).

(1-8-5) Transverse Movement Processing for Cards of User Deck (FIG. 22)

The CPU 21 of the game server 20 is configured to determine the opponent card middle position (CL_opp) that is the column on the matrix and indicates the middle position of the card group of the opponent deck. As described above, the opponent card middle position is the column located in the middle of the column of the leftmost cell in which a card is placed and the column of the rightmost cell in which a cards is placed in the region for the opponent deck. When the middle position between columns is the middle of cells, the column located on the left side of the middle position is defined as the opponent card middle position.

After determining the opponent card middle position, the CPU 21 is configured to determine the order of processing the respective cards of the card group of the user deck (S162). As described above, the processing is executed in the following preferential order of (b-1) to (b-4). After determining the order of processing the respective cards, a series of processing steps in S164 to S174 are configured to be executed for the respective cards in accordance with the processing order:

(b-1) a right-to-left order starting from the card placed in the opponent card middle position regarding one or more cards placed in the first row;

(b-2) a right-to-left order starting from the card placed in the opponent card middle position regarding one or more cards placed in the respective rows other than the first row;

(b-3) a left-to-right order regarding one or more cards placed rightward of the opponent card middle position in the first row; and

(b-4) a left-to-right order regarding one or more cards placed rightward of the opponent card middle position in the respective rows other than the first row.

As long as the processing target card is a card to be processed in the aforementioned (b-1), the processing target card is placed in the first row (YES in S164) and is placed in or leftward of the opponent card middle position CL_opp (YES in S166). Hence, the CPU 21 is configured to execute the processing of moving the processing target card to the cell located on the right side thereof (S168). It should be noted that when there is herein other card in a destination cell for the processing target card, the processing target card is not moved thereto. In S168, the CPU 21 is configured to create the match-up processing data so as to update data of the attribute Present-position of the card to be herein moved. After completion of the processing of S168, when all the cards of the user deck have not been processed yet (NO in S174), the CPU 21 is configured to return to S164 for processing the next card.

As long as the processing target card is a card to be processed in the aforementioned (b-2), the processing target card is not placed in the first row (NO in S164). Hence, the CPU 22 is configured to execute the processing of moving the processing target card (S172) similarly to (i.e., in conjunction with) the processing of moving the card that has been placed in the cell located immediately forward of the processing target card on the match-up field in the beginning of the processing in FIG. 22. In other words, when the processing target card is a card placed in the cell located in the second or subsequent rows, the processing target card is configured to be moved similarly to the movement aspect that has been already executed for the card to be processed in the aforementioned (b-1). In S172, the CPU 21 is configured to create the match-up processing data so as to update data of the attribute Present-position of the card to be herein moved. After completion of the processing of S172, when all the cards of the user deck have not been processed yet (NO in S174), the CPU 21 is configured to return to S164 for processing the next card.

As long as the processing target card is a card to be processed in the aforementioned (b-3), the processing target card is placed in the first row (YES in S164) and is placed in or rightward of the opponent card middle position (NO in S166). Hence, the CPU 21 is configured to execute the processing of moving the processing target card to the cell located on the left side thereof (S170). It should be noted that when there is herein other card in a destination cell for the processing target card, the processing target card is not moved thereto. In S170, the CPU 21 is configured to create the match-up processing data so as to update data of the attribute Present-position of the card to be herein moved. After completion of the processing of S170, when all the cards of the user deck have not been processed yet (NO in S174), the CPU 21 is configured to return to S164 for processing the next card.

As long as the processing target card is a card to be processed in the aforementioned (b-4), the processing target card is not placed in the first row (NO in S164). Hence, the CPU 21 is configured to execute the processing of moving the processing target card (S172) similarly to (i.e., in conjunction with) the processing of moving the card that has been placed in the cell located immediately forward of the processing target card on the match-up field in the beginning of the processing in FIG. 22. In other words, when the processing target card is a card placed in the cell located in the second or subsequent rows, the processing target card is configured to be moved in a similar way that has been already executed for the card to be processed in the aforementioned (b-3). In S172, the CPU 21 is configured to create the match-up processing data so as to update data of the attribute Present-position of the card to be herein moved. After completion of the processing of S172, when all the cards of the user deck have not been processed yet (NO in S174), the CPU 21 is configured to return to S164 for processing the next card.

Completion of processing of the last one of the processing target cards to be processed in the aforementioned (b-4) means that the processing of transversely moving all the cards of the opponent deck has been completed (YES in S174).

The flow of the match-up processing has been explained above in detail.

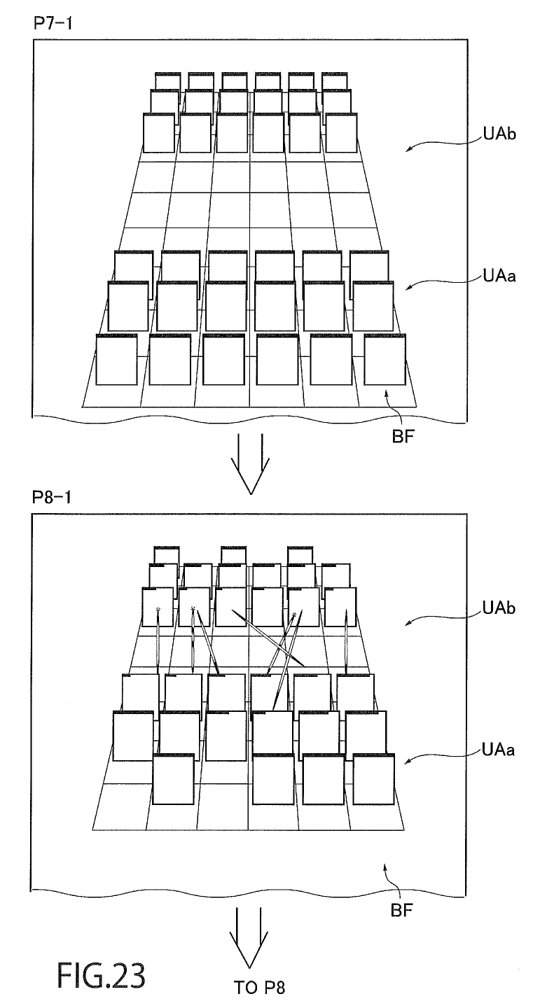

It should be noted that the image P7 of FIG. 11B exemplifies the configuration that a match-up is started in a condition in which the user deck and the opponent deck are faced without interval. However, the condition in which a match-up is started is not limited to this. For example, as shown in an image P7-1 of FIG. 23, the base row of the region UAa for the user deck and that of the region UAb for the opponent deck may be configured to be separated at a predetermined interval (e.g., three rows) in the beginning of a match-up. After the match-up is started, as shown in an image P8-1, the match-up may be configured to be played such that the base lines of the respective regions approach to each other.

(1-9) Flow of Drawing Processing of Present Embodiment

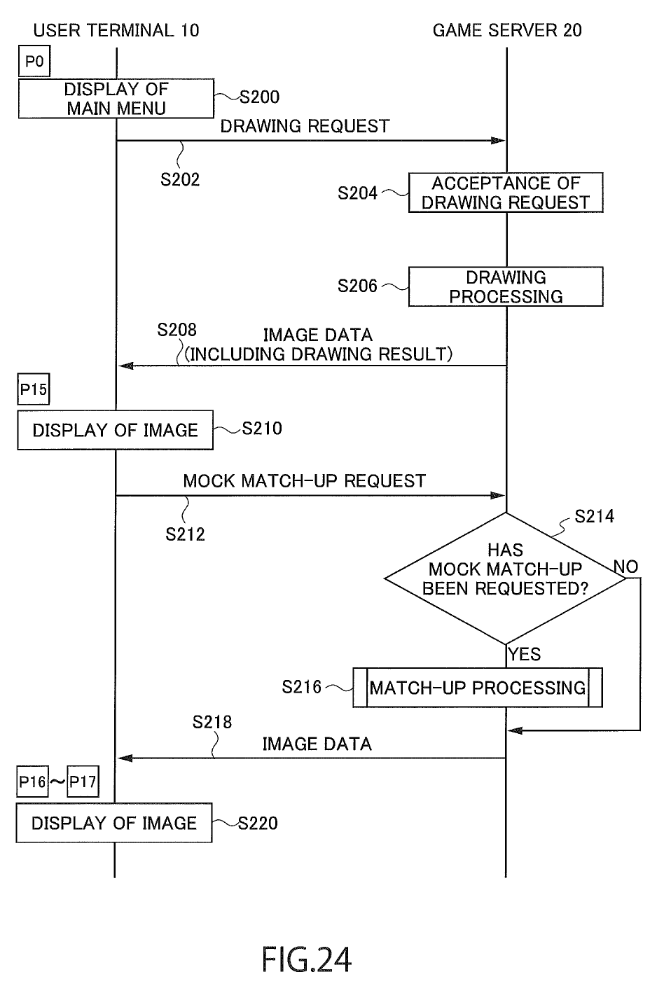

Next, the drawing processing of the present embodiment will be explained with reference to FIG. 24. FIG. 24 is a flowchart showing the drawing processing of the present embodiment.

When a user selects the button b4 (“drawing (mock match-up))” (see the image P0 of FIG. 15) while the main menu is displayed on the user terminal 10 (S200), the CPU 11 of the user terminal 10 is configured to accept a drawing request and sends it to the game server 20 (S202). It should be noted that the data configuration of the drawing request configured to be sent by selecting the button b3 (“drawing”) and that of the drawing request configured to be sent by selecting the button b4 (“drawing (mock match-up)”) can be distinguished by the CPU 21. The CPU 21 of the game server 20 is configured to accept the received drawing request (S204) and execute the drawing processing (S206).

Specifically, the CPU 21 is configured to randomly select one or more cards (drawn cards) to be given to the user from a plurality of cards that are contained in the card data table and are respectively specified by values of the attribute Card-ID. The number of drawn cards is not particularly limited. The CPU 21 of the game server 20 is configured to generate image data containing information for specifying the drawn cards (the values of the attributes Name, Card-image, and so forth) as a result of drawing and send the image data to the user terminal 10 (S208). In a case in which the drawing request received by the game server 20 in S202 is a drawing request that includes playing of a mock match-up, the image data to be sent to the user terminal 10 in S208 is configured to contain a button for starting a mock match-up as shown in the image P15 of FIG. 15. The CPU 11 of the user terminal 10 is configured to display an image in the display unit 16 based on the obtained image data (S210).

When the button for starting a mock match-up is selected by the user, a mock match-up request is configured to be sent from the user terminal 10 to the game server 20 (S212). When determining that the mock match-up request has been obtained (YES in S214), the CPU 21 of the game server 20 is configured to execute the match-up processing between a user deck and a drawn card deck (S216). The content of the match-up processing in S216 is the same as that of the match-up processing shown in FIG. 18. In this case, the CPU 21 is configured to execute the match-up processing between the drawn card deck built based on the drawn cards obtained in S206 and the user deck read out from the deck data table. When the match-up processing is completed, the CPU 21 is configured to send image data, which contains a reproducible file based on the match-up processing data created in processing the match-up, to the user terminal 10 (S218). The CPU 11 of the user terminal 10 is configured to display the obtained reproducible file in the display unit 16. Thus, the user can watch the content of the mock match-up (S220).

In the aforementioned embodiment, as shown in the image P16 of FIG. 15, the output means 57 is configured to output, to the user terminal 10, output data that contains information indicating in which of user card placeable cells user cards included in the user deck have been placed in a mock match-up and information indicating in which of drawn card placeable cells drawn cards have been placed in the mock match-up. Hence, this configuration is advantageous in making the user easily recognize the actual performance of each drawn card.

In other words, the match-up processing of the present embodiment includes complex match-up elements such as variation in value of the attribute Attack-power in accordance with distance between cards, the attribute Hit-accuracy of attack, the attribute Avoidance-skill in defense, and so forth. Hence, it is difficult for a user to recognize whether or not each drawn card effectively works in an actual match-up only by separately checking the parameters of drawn cards. However, by building a drawn card deck based on the drawn cards and playing a mock match-up between the drawn card deck and a user deck, effectiveness of layout, movement, attack, defense and so forth of each drawn card in an actual match-up is presented to the user in a visually user-friendly manner. In other words, the user normally grasps the actual performance of the user deck sufficiently. Hence, a match-up between the user deck and the drawn card deck makes the user easily recognize the actual performance of each drawn card. For example, in the match-up processing, each card is configured to disappear when its value of the attribute HP becomes zero during a match-up. Hence, when a given card in the card group of the drawn card deck remains on the match-up field in the end or the latter half of the mock match-up, the actual performance of the given card can be judged as relatively equivalent to or better than that of each card of the user deck. Therefore, the given card can be a prospective card to be then incorporated into the user deck.

If a match-up between users is configured to be executed such that predetermined parameters associated with users are consumed, there is a possibility that a user is reluctant to use a given newly obtained drawn card in a match-up with other user in order to estimate the actual performance of the newly obtained drawn card. In contrast, the aforementioned mock match-up is not a match-up between users, and hence, parameters are not consumed. This motivates a user to actively use a newly obtained drawn card.

(1-10) Modifications

Modifications of the present embodiment will be hereinafter explained.

(1-10-1) Modification 1

As described above, when a drawn card deck is built based on drawn cards, it is preferable to place the respective drawn cards based on the values of the attribute Attack-range of the respective cards. Alternatively, it is preferable to execute the drawing processing such that the respective drawn cards can be placed based on the values of the attribute Attack-range of the respective drawn cards. For example, when placed on the 3×6 matrix as shown in FIG. 9, the drawn cards can be all placed in accordance with the values of the attribute Attack-range of the respective cards (example of layout information) by, for instance, drawing cards as follows.

### Example 1 of Card Drawing

The number of cards with the value of the attribute Attack-range of “SR”: 6

The number of cards with the value of the attribute Attack-range of “MR”: 6

The number of cards with the value of the attribute Attack-range of “LR”: 6

### Example 2 of Card Drawing

The number of cards with the value of the attribute Attack-range of “SR”: 2

The number of cards with the value of the attribute Attack-range of “MR”: 3
The number of cards with the value of the attribute Attack-range of “LR”: 5

It should be noted that, in a case in which there are a large number of drawn cards, a drawn card deck cannot be necessarily built in a condition in which all the drawn cards are placed in accordance with the values of the attribute Attack-range of the respective drawn cards. For example, the match-up field exemplified in FIG. 9 has 6 cells in the first row; however, if there are herein seven drawn cards that the value of the attribute Attack-range is “SR”, at least one of the drawn cards cannot be placed in the first row. In light of this, when a given drawn card cannot be placed in a cell on the match-up field based on its value of the attribute Attack-range, in other words, when a given drawn card is placed in a position in which the given drawn card has difficulty in performing best in match-ups, it is preferable to inform a user that layout based on the value of the attribute Attack-range cannot be applied to the given drawn card, and thus, to inform the user that it is difficult to appropriately judge whether or not the given drawn card can be effectively utilized.

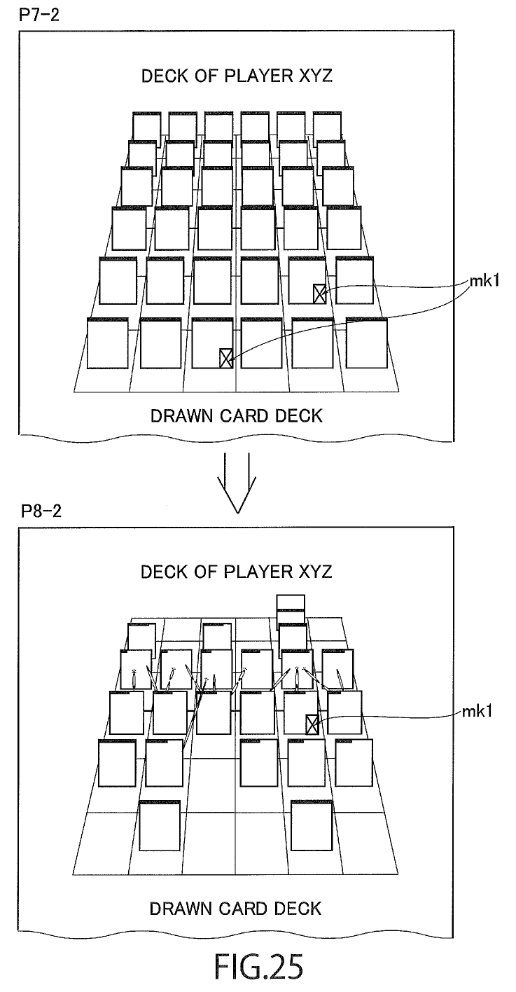

In other words, when layout based on the value of the attribute Attack-range cannot be applied to a given drawn card, the output means 57 is preferably configured to output image data in a form enabling a user to recognize that layout based on the value of the attribute Attack-range cannot be applied to the drawn card. FIG. 25 is a diagram showing an example of images configured to be displayed on the user terminal when a user plays a mock match-up. FIG. 25 shows that layout based on the value of the attribute Attack-range could have not been applied to cards, on each of which mark mk1 is displayed, in the card group of the drawn card deck.

(1-10-2) Modification 2

The present modification is characterized in that a return match of a mock match-up can be played again after the layout of respective drawn cards in a drawn card deck are changed. In the present modification, the game server 20 is provided with the acceptance means 58 and the change means 59 (see FIG. 16) as its functions in order to execute a return match of a mock match-up.

The acceptance means 58 has a function of accepting a user request for changing the layout of drawn cards included in a drawn card deck. A return match request to be described is an example of a user request for changing the layout of drawn cards included in a drawn card deck. Acceptance of the request is configured to be executed by the CPU 11 of the user terminal 10 and the CPU 21 of the game server 20.

The change means 59 has a function of changing the layout of the drawn cards, in other words, a function of re-building the drawn card deck, in response to acceptance of the aforementioned request by the acceptance means 58. Card layout of the drawn card deck to be re-built may be arbitrarily set as long as it is different from that of the drawn card deck in the pre-change condition. The method of building the drawn card deck is not particularly limited, and the CPU 21 of the game server 20 may re-build the drawn card deck as follows. When the drawn card deck has been built based on the values of the attribute Attack-range of the cards in the pre-change condition, the columnar positions of the cards may be changed within each row randomly or in accordance with a predetermined rule in re-building the drawn card deck. For example, when six cards with “SR” as the value of the attribute Attack-range have been placed in the first row in the drawn card deck in the pre-change condition, the columnar positions of these cards are randomly changed within the first row in re-building the drawn card deck. When the drawn card deck has been built irrespective of the values of the attribute Attack-range of the cards in the pre-change condition, layout of the cards may be randomly changed irrespective of the values of the attribute Attack-range of the cards in re-building the drawn card deck.

In the present modification, the execution means 56 is configured to execute a match-up between a user deck and a drawn card deck, which is played based on the layout of the respective cards indicated by the user deck obtained by the obtainment means 54 and the drawn card layout changed by the change means 59, whereas the output means 57 is configured to output image data for making the user recognize the content of the match-up using information to be obtained as a result of the processing of the match-up.

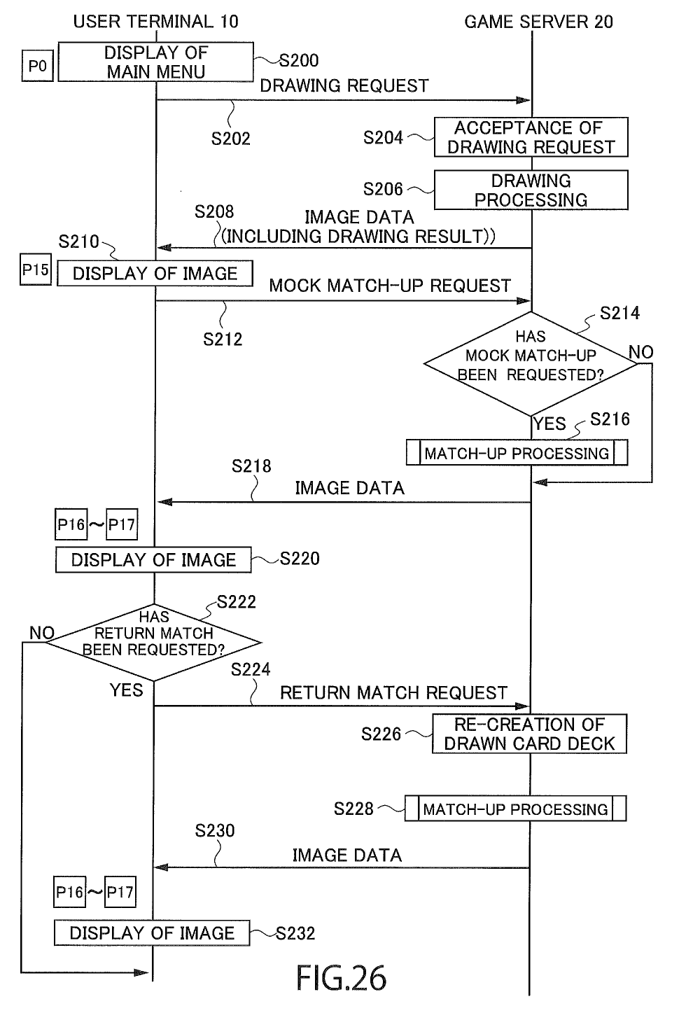

The drawing processing of the present modification will be explained with reference to FIG. 26. FIG. 26 is a flowchart showing the drawing processing of the present modification. The flowchart of FIG. 26 is different from that of FIG. 24 in S220 and subsequent steps. It is herein assumed that a button for requesting a return match (not shown in the drawings) is displaced on an image configured to be displayed on the user terminal 10 in S220. When a user selects the button, the CPU 11 of the user terminal 10 is configured to accept a return match request from the user and send the return match request to the game server 20 (S224).

When receiving the return match request, the CPU 21 of the game server 20 is configured to re-build the drawn card deck (S226). After re-building the drawn card deck, the CPU 21 is configured to execute the match-up processing between the user deck and the re-built drawn card deck (i.e., return match processing) (S228). The content of the match-up processing in S228 is the same as that of the match-up processing shown in FIG. 18. After the match-up processing is completed, the CPU 21 is configured to send, to the user terminal 10, image data that contains a reproducible file based on the match-up processing data created in the match-up processing (S230). The CPU 11 of the user terminal 10 is configured to display the received reproducible file on the display unit 16. Thus, the user can watch the content of the return match of the mock match-up (S232).

In the present modification, a return match is configured to be played between a user deck and a drawn card deck, the layout of which has been changed, in response to acceptance of a request from a user. Then, the content of the return match is display. Such a return match is preferable in some situations, for instance, where it was unclear for a user whether or not the respective drawn cards had effectively worked in a previous match-up, or where a user wants to check effectiveness of the respective drawn cards in a match-up from other perspective of view by placing the drawn cards in different positions.

(1-10-3) Modification 3

The output means 57 may be configured to output image data in a form enabling a user to recognize changes in at least either the positions or the parameters between the respective drawn cards included in the drawn card deck based on the layout determined by the determination means 55 and those included in the drawn card deck based on the layout changed by the change means 59. In other words, when the return match of the mock match-up explained in the aforementioned modification 2 is executed, image data may be configured to be outputted in a form enabling a user to recognize change in at least either the positions or the parameters between the respective drawn cards of the drawn card deck in the pre-change condition and those of the drawn card deck in the post-change condition.

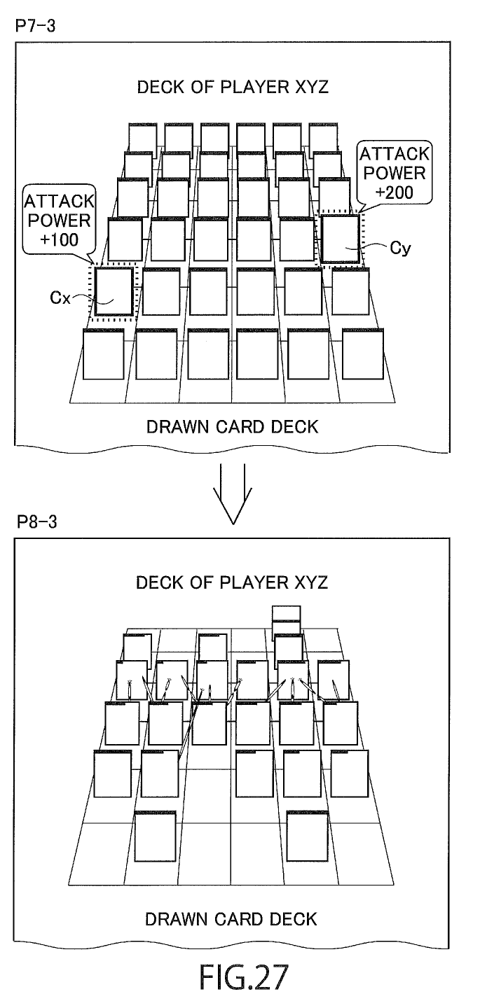

FIG. 27 shows an example of the image to be displayed in the present modification. In the example shown in FIG. 27, changes in attack power of cards Cx and Cy are displayed on an image P7-3 configured to be displayed in the beginning of a return match of a match-up.

To implement the present modification, after re-building of the drawn card deck in S226 in the flowchart of FIG. 26, the CPU 21 of the game server 20 may be configured to execute a processing of comparison between the drawn card deck built in S216 and that re-built in S226. The comparison processing is a processing of comparing the positions and the parameters between the respective drawn cards of the drawn card deck in the pre-change condition and those of the drawn card deck in the post-change condition. For example, as described above, when the value of the attribute of Attack-power of a given card is configured to be changed based on the value of the attribute Attack-range of the given card and the distance between the given card and an attack target card, the comparison processing includes a processing of calculating the amount of change in values of the attribute Attack-power between the respective drawn cards of the drawn card deck in the pre-change condition and those of the drawn card deck in the post-change condition.

In the present modification, when the layout of the drawn card deck is changed, changes in positions and parameters (values of the attributes Attack-power, Defense-power and so forth) between the respective drawn cards of the drawn card deck in the pre-change condition and those of the drawn card deck in the post-change condition are configured to be displayed in a form recognizable by a user. Hence, this makes the user easily recognize information related to the respective drawn cards in pre- and post-change conditions.

(1-10-4) Modification 4

The aforementioned embodiment has explained the configuration of outputting image data indicating the content of a mock match-up after a user has obtained cards. However, the timing of obtaining cards and the timing of displaying the content of the mock match-up may be reversed. In other words, in the present modification, the association means 53 is configured to associate drawn cards selected by the selection means 52 with a user after the output means 57 outputs image data.

First, a setting may be exemplified with which a user is allowed to perform re-drawing (re-drawing) after a mock match-up as an example of reversing the obtainment timing and the display timing. In this example, the user may give an instruction to perform re-drawing when the user is not satisfied with the abilities of cards selected by drawing or so forth after watching the content of a mock match-up. Other mock match-up is configured to be performed based on the cards selected as a result of performing re-drawing. When giving a predetermined confirmation instruction after the mock match-up, the user may be given one or more cards selected immediately before the predetermined confirmation instruction. In this example, the user can obtain the one or more selected cards after checking that the one or more selected cards are advantageous in a match-up.

On the other hand, as other example of reversing the obtainment timing and the display timing, a setting may be exemplified with which a user is given a chance of simultaneously or consecutively performing drawing plural times and mock match-ups are played based on the cards selected in the respective events of drawing. Here, the user is given a chance of obtaining cards selected in any of the plural events of drawing after watching the contents of the mock match-ups. In this example, the user can obtain cards advantageous in match-ups through comparison among the contents of plural mock match-ups.

In the present modification, the timing of associating cards with the user comes after the user checks the content of a mock match-up. This enables the user to select whether or not the user should obtain the cards based on the content of the mock match-up.

It should be noted that association by the association means 53 may include planning/reservation of association by a user. For example, it is assumed that prior to a given event, a user is informed of chances of obtaining specific cards when a predetermined condition is satisfied in the given event. At this time, prior to the given event, the user may be allowed to play a mock match-up between the specific cards and a user deck in response to a user operation so as to be capable of checking the content of the mock match-up. When, prior to the given event, the user can confirm effectiveness of the specific cards to be obtainable in the given event due to this configuration, the user is motivated to join in the given event.

The aforementioned embodiment and modifications have explained the configuration in which a user is given a plurality of drawn cards as obtained cards, a drawn card deck is built by the plural drawn cards, and a mock match-up is played between the drawn card deck and a user deck. However, the present invention is not limited to the configuration. When the number of drawn cards is only one, a mock match-up may be played using the single drawn card. In other words, the opponent of the user deck in a match-up is not necessarily a deck composed of a plurality of obtained cards. For example, when the single obtained card has quite high attack power and skill, the user can recognize that the obtained card is quite effective in match-ups by playing a mock match-up between the obtained card and the user deck.

The aforementioned embodiment and modifications have explained the configuration in which the first object group is the user deck. However, the present invention is not limited to this configuration. As described above, the reason for using the user deck in a mock match-up is that the user has been normally used the user deck, and therefore, can easily grasp effectiveness of obtained cards in a match-up based on the user deck as a benchmark. Therefore, a deck to be used in a mock match-up may not be limited to the user deck as long as its actual performance in match-ups is grasped by the user. For example, a deck of other user such as a colleague/rival of the user may be used in a mock match-up with the user.

Regarding the mock match-up in the aforementioned embodiment, the configuration has been explained in which the user deck and the drawn card deck are placed on the match-up field, the mock match-up is played between the both decks, and the content of the mock match-up is presented to the user. However, the content of the mock match-up is not limited to the aforementioned one in which card layout and card movement are performed. As explained in (1-4), it is only required to enable the user to recognize effectiveness of drawn cards as obtained cards through a mock match-up. Hence, the content of a mock match-up may be suitably designed as long as effectiveness of cards is recognizable even without card layout and card movement. For example, match-up use cards and drawn cards of the user may be placed in alignment in accordance with a predetermined rule without placing the user deck on the match-up field. Even in this case, when it is turned out that a specific drawn card exerts a skill higher than expectation of the user due to combinational effect of cards, the user can recognize that the specific drawn card is an effective card in match-ups.

### (2) Second Embodiment

The first embodiment has explained the configuration of implementing the game in the form of a so-called browser game in which communication is performed between each user terminal 10 and the game server 20 via HTTP and each user terminal 10 displays a game image by interpreting the HTML document obtained from the game server 20. However, the present invention is not limited to the configuration. The game of the present embodiment may be implemented in the form of a so-called native application game in which each user terminal 10 voluntarily executes the processing of the game by running the game program downloaded thereto whereby sending/receiving processing is limited between each user terminal 10 and the game server 20. In the form of the native application game, the CPU 11 of each user terminal 10 is configured to display an image on the display unit 16 by generating image data without utilizing a web browser.

In the present embodiment, an exemplary configuration will be explained in which the game of the first embodiment is implemented in the form of the native application game. It should be noted that hardware configuration of the present embodiment may be the same as that of the first embodiment. In the form of the native application game of the present embodiment, it is assumed that each user terminal 10 is configured to execute most of the processing. The game server 20 may be configured to execute part of the processing of the game, which will not be hereinafter explained (e.g., a drawing processing of giving cards to a user by drawing, a present processing of giving cards to a user by a game administrator, etc.) and send a result of processing to each user terminal 10.

In the present embodiment, each user terminal 10 is configured to receive a game program from the server of the game administrator in response to a predetermined operation of the user and store the received game program in the storage 18. When the game is activated by each user terminal 10, communication is established between each user terminal 10 and the game server 20, a log-in processing is executed, and the data table group (the user data table, the card data table, the possessed card data table and the deck data table) is sent from the game server 20 to each user terminal 10. The data table group sent to each user terminal 10 is stored in the storage 18 of each user terminal 10. In this case, the data table group stored in the storage 18 is updated every time the log-in processing is executed.

In the present embodiment, each user terminal 10 is configured to execute the match-up processing (FIG. 18) and the processing in accordance with a drawing request (FIG. 24).

It should be noted that in order to prevent the possessed card data table from being falsified in each user terminal 10, the possessed card data table stored in each user terminal 10 is configured to be sent to the game server 20 every time a predetermined processing by each user terminal 10 is finished, or alternatively, at the timing of logging out from the game. The game server 20 is configured to compare the received possessed card data table and the possessed card data table stored in the storage 25. When confirming that data falsification has not been performed, the game server 20 is configured to update the possessed card data table stored in the storage 25 based on the received possessed card data table.

The embodiments and modifications of the present invention have been explained above. The present invention is not limited to the aforementioned embodiments and so forth. Additionally, it is apparent that a variety of improvements and variations can be made for the embodiments without departing from the scope of the present invention. The technical features described in the aforementioned embodiments and the respective modifications may be combined on an as-needed basis.

For example, in the aforementioned embodiments and modifications, an operational input by pressing a predetermined button of each user terminal and an operational input by touching the display screen of each user terminal equipped with a touch panel function are defined as a predetermined operational input into each user terminal. However, the operational input is not limited to the above. An operational input by shaking each user terminal equipped with an acceleration sensor or an operational input by a gesture (gesture input) may be defined as the operational input. In the gesture input, when a predetermined gesture is performed with respect to each user terminal equipped with an image capturing function, each user terminal is configured to perform image recognition with respect to the gesture and recognize an operational input preliminarily associated with the gesture. Alternatively, when a voice recognition program is executable in each user terminal, operational input may be performed by inputting voice.

### APPENDIX

Based on the aforementioned description, the present invention can be grasped, for instance, as follows.

An aspect of the present invention relates to an information processing device (20) configured to be accessible to a storage device storing first object group information indicating a first object group including a plurality of first objects to be used by a user in a match-up. The information processing device includes:

selection means (52) configured to select a second object based on an operation by the user;

association means (53) configured to associate the second object selected by the selection means (52) with the user;

obtainment means (54) configured to obtain the first object group information associated with the user from the storage device (25); and

output means (57) configured to output output data based on information obtained as a result of processing a match-up performed between the first object group obtained by the obtainment means (54) and the second object, the output data causing the user to recognize a content of the match-up.

“Information processing device” may be a stand-alone game console, a user terminal (e.g., a portable terminal, a personal computer, etc.), a server on a network, or so forth. The entity of the information processing device may be suitably defined in accordance with an aspect of implementing a game. For example, in a case in which the respective functions of the information processing device are configured to be implemented in the game console or the user terminal by a user, the game console or the user terminal corresponds to the information processing device of the present invention. Alternatively, in a case in which the user terminal as a client has a function of accepting an operational input from a user and a function of displaying an image and the respective functions of the information processing device are configured to be substantially implemented by the server capable of communicating with the user terminal, the server corresponds to the information processing device of the present invention.

“Objects” may be any type of display object as long as they can be visually recognizable by the user, and are not limited to the cards of the aforementioned embodiment. For example, the objects may be simple images such as illustrations or photographs, or alternatively, may be stereoscopic characters formed by 3D images. In other words, any type of objects may be employed as long as they are media usable in a game. Additionally, the objects may be targets configured to be collected by the user in the game, and further, may be targets configured to be fostered in the game.

“Storage device” may be an arbitrarily constructed memory device, for instance, a flash memory, an HDD (Hard Disk Drive) or so forth. Additionally, the storage device may be embedded in the information processing device, or alternatively, may be an external device configured to be accessible from the information processing device through wired or wireless communication.

“Selecting an object by a user” may refer to a configuration in which an object is selected when a user executes a function of a game such as drawing, a configuration that an object is selected as a result of progression of a game, or a configuration in which an object is selected regardless of progression of a game (e.g., a configuration in which an object is selected as a present to be given to a user by other user).

“Associating an object with a user” may be suitably defined in accordance with the setting of a game, and for instance, may refer to a configuration in which an object is set as an obtained object of a user, a configuration that an object planned to be obtained by a user is preliminarily associated with the user, or a configuration in which an object is reserved by a user for the purpose of obtaining the object.

A configuration will be hereinafter explained in which the second object associated with the user is an object obtained by the user (the obtained object of the user).

In the aforementioned information processing device, the content of a match-up performed between the first object group to be used by the user in match-ups and the object obtained by the user based on an operation of the user (the second object) is configured to be presented to the user in a form recognizable by the user. The first object group is an object group normally used by the user in match-ups and the strength thereof in match-ups is grasped by the user. Hence, by recognizing the content of the aforementioned match-up, the user is able to easily recognize whether or not the obtained object (the second object) can be effectively utilized when incorporated into the first object group.

The association means (53) may be configured to associate the second object selected by the selection means (52) with the user after the output means (57) outputs the output data.

According to the aforementioned configuration, when the user selects the second object a plurality of times and is accordingly given a plurality of chances that the second object can be associated with the user, for instance, any one of the second objects selected plural times can be associated with the user (e.g., obtained by user) after the user checks match-ups between the first object group and the respective second objects selected plural times. In other words, by setting the timing of associating the second object with the user so as to be after the user checks the content of the match-ups, this enables the user to determine which one to select among the second objects selected plural times based on the content of the match-ups.

The output data output by the output means (57) may contain: information indicating a region among a plurality of object placeable regions, the region on which each of the first objects included in the first object group has been placed in the match-up; and information indicating a region among a plurality of object placeable regions, the region on which the second object has been placed in the match-up.

This configuration is provided on the premise that the match-up between the first object group and the second object is performed by placing the respective objects. In the match-up to be performed by thus placing objects, the content thereof becomes relatively complex. Hence, it is possible to more advantageously exert the effect that the user can easily recognize whether or not the second object, which is for instance the obtained object, can be effectively utilized when incorporated into the first object group.

Each of the objects may be associated with layout information regarding layout of each of the objects.

The information processing device may further include determination means (55) configured to determine a region among the plurality of object placeable regions, the region on which the second object has been placed in the match-up, based on the layout information associated with the second object.

In this configuration, each of the objects is placed in accordance with the layout information thereof in the match-up between the first object group and the second object. Hence, the match-up is performed after appropriate positioning is performed for each of the objects. Therefore, the second object is supposed to be placed in such a position that the second object is likely to achieve the actual performance thereof in the match-up, and this enables the user to more reliably judge whether or not the second object can be effectively utilized. Additionally, by determining a position of the second object based on the layout information of the second object, it is possible to implement a tutorial function of presenting an appropriate position of the second object to the user.

When the second object cannot be placed based on the layout information of the second object in a region corresponding to the layout information of the second object, the output means (57) may be configured to output the output data in a form enabling the user to recognize that the second object cannot be placed based on the layout information of the second object.

For example, when a plurality of second objects exist but object placeable positions are limited, it may happen that all the second objects cannot be necessarily placed based on the layout information thereof. In light of this, when the second card cannot be placed based on the layout information thereof, in other words, when the second object is placed in a position where it has difficulty in performing best in the match-up, the user is informed that the second object cannot be placed based on the layout information thereof, and is thus informed of difficulty in appropriately judging whether or not the second object can be effectively utilized.

The information processing device may further include acceptance means (58) configured to accept from the user a request for relocating the second object from the region in which the second object has been placed to other region.

The information processing device may further include change means (59) configured to relocate the second object from the region in which the second object has been placed to the other region in response to acceptance of the request by the acceptance means (58).

The output means (57) may be configured to output the output data based on information obtained as a result of processing the match-up between the first object group and the second object, and the match-up is herein performed based on regions indicated by the object group information obtained by the obtainment means (54) as regions in which the first objects have been respectively placed and a region to which the second object has been relocated by the change means (59), the output data causing the user to recognize a content of the match-up.

In this configuration, a match up (return match) is configured to be performed again between the first object group and the second object relocated to other position in response to acceptance of the request from the user, and the content of the match-up is configured to be displayed. Such a return match is preferable for a case in which it was unclear for the user in a previous match-up whether or not the second object effectively worked in the match-up, a case in which the user wants to check effectiveness of the second object in a match-up from other perspective of view by placing the second object in a different position, and so forth.

The output means (57) may be configured to output the output data in a form enabling the user to recognize change between the second object in one condition and the second object in other condition regarding at least one of object information and the region in which the second object is placed. The one condition is that the determination means (55) has determined a region among the plurality of object placeable regions, the region on which the second object has been placed in the match-up, whereas the other condition is that the change means (59) has relocated the second object from the region in which the second object has been placed to the other region.

In this configuration, when the second object is relocated to other region, changes between the second object in a pre-change condition and that in a post-change condition regarding position and object information (parameters such as attack power and defense power) are configured to be displayed in a form recognizable by the user. This makes the user easily recognize information related to the second object in pre- and post-change conditions.

Another aspect of the present invention may relate to an information processing system (1). The information processing system may include a user terminal (10) and a server (20) configured to be accessed from the user terminal (10). At least one of the user terminal (10) and the server (20) may be configured to be accessible to a storage device (25) storing first object group information indicating a first object group including a plurality of first objects to be used by a user in a match-up.

At least one of the user terminal (10) and the server (20) may include:

selection means (52) configured to select a second object based on an operation by the user;

association means (53) configured to associate the second object selected by the selection means (52) with the user;

obtainment means (54) configured to obtain the first object group information associated with the user from the storage device (25); and

output means (57) configured to output output data based on information obtained as a result of processing a match-up performed between the first object group obtained by the obtainment means (54) and the second object, the output data causing the user to recognize a content of the match-up.

Yet another aspect of the present invention may relate to a program configured to cause a computer to implement a plurality of means. The computer may be configured to be accessible to a storage device (25) storing first object group information indicating a first object group including a plurality of first objects to be used by a user in a match-up. The plurality of means may include:

selection means (52) configured to select a second object based on an operation by the user;

association means (53) configured to associate the second object selected by the selection means (52) with the user;

obtainment means (54) configured to obtain the first object group information associated with the user from the storage device (25); and

output means (57) configured to output output data based on information obtained as a result of processing a match-up performed between the first object group obtained by the obtainment means (54) and the second object, the output data causing the user to recognize a content of the match-up.

Further yet another aspect of the present invention may relate to a computer readable storage medium (e.g., an optical disc, a magnetic disk, etc.) for storing the aforementioned program.

In other words, further yet another aspect of the present invention may relate to a non-transitory computer-readable recording medium. The recording medium may include a program enabling the computer to execute a method.

The method may be configured to be executed by access to a storage device storing first object group information indicating a first object group including a plurality of first objects to be used by a user in a match-up.

The method may include:

selecting a second object based on an operation by the user;

associating the selected second object with the user;

obtaining the first object group information associated with the user from the storage device; and

outputting output data based on information obtained as a result of processing a match-up performed between the obtained first object group and the second object, the output data causing the user to recognize a content of the match-up.

It should be noted that for easy understanding of the present invention, reference signs assigned in the drawings are added in brackets to the aforementioned appendix on an as-needed bases. However, it is not intended to restrict the information processing device and so forth according to the present invention to the aspects shown in the drawings by adding the reference signs to the appendix.

1. An information processing device configured to be accessible to a storage device storing first object group information indicating a first object group including a plurality of first objects to be used by a user in a match-up, comprising:
a selector configured to select a second object based on an operation by the user;
an associator configured to associate the second object selected by the selector with the user;
an obtainer configured to obtain the first object group information associated with the user from the storage device; and
an output configured to output output data based on information obtained as a result of processing a match-up performed between the first object group obtained by the obtainer and the second object, the output data causing the user to recognize a content of the match-up.

2. The information processing device according to claim 1, wherein the associator is configured to associate the second object selected by the selector with the user after the output outputs the output data.

3. The information processing device according to claim 1, wherein the output data output by the output contains: information indicating a region among a plurality of object placeable regions, the region on which each of the first objects included in the first object group has been placed in the match-up; and information indicating a region among a plurality of object placeable regions, the region on which the second object has been placed in the match-up.

4. The information processing device according to claim 3, wherein
the second object is associated with layout information regarding layout of the second object, and
the information processing device further comprises a determinator configured to determine a region among the plurality of object placeable regions, the region on which the second object has been placed in the match-up, based on the layout information associated with the second object.

5. The information processing device according to claim 4, wherein when the second object cannot be placed based on the layout information of the second object in a region corresponding to the layout information of the second object, the output is configured to output the output data in a form enabling the user to recognize that the second object cannot be placed based on the layout information of the second object.

6. The information processing device according to claim 4, further comprising:
an acceptor configured to accept from the user a request for relocating the second object from the region in which the second object has been placed to other region, and
a changer configured to relocate the second object from the region in which the second object has been placed to the other region in response to acceptance of the request by the acceptor, wherein
the match-up is performed based on regions indicated by the object group information obtained by the obtainer as regions in which the first objects have been respectively placed and a region to which the second object has been relocated by the change changer.

7. The information processing device according to claim 6, wherein the output is configured to output the output data in a form enabling the user to recognize change in at least one of object information of the second object and the region in which the second object is placed, before and after the relocation of the second object by the changer.

8. An information processing system, the information processing system including a user terminal and a server configured to be accessed from the user terminal, at least one of the user terminal and the server being configured to be accessible to a storage device storing first object group information indicating a first object group including a plurality of first objects to be used by a user in a match-up, wherein
at least one of the user terminal and the server includes:
a selector configured to select a second object based on an operation by the user;
an associator configured to associate the second object selected by the selector with the user;
an obtainer configured to obtain the first object group information associated with the user from the storage device; and
an output configured to output output data based on information obtained as a result of processing a match-up performed between the first object group obtained by the obtainer and the second object, the output data causing the user to recognize a content of the match-up.

9. A non-transitory computer-readable recording medium, the recording medium including a program enabling a computer to execute a method, the method configured to be executed by access to a storage device storing first object group information indicating a first object group including a plurality of first objects to be used by a user in a match-up, the method comprising:
selecting a second object based on an operation by the user;
associating the selected second object with the user;
obtaining the first object group information associated with the user from the storage device; and
outputting output data based on information obtained as a result of processing a match-up performed between the obtained first object group and the second object, the output data causing the user to recognize a content of the match-up.

10. The information processing device according to claim 2, wherein the output data output by the output contains: information indicating a region among a plurality of object placeable regions, the region on which each of the first objects included in the first object group has been placed in the match-up; and information indicating a region among a plurality of object placeable regions, the region on which the second object has been placed in the match-up.

11. The information processing device according to claim 5, further comprising:
an acceptor configured to accept from the user a request for relocating the second object from the region in which the second object has been placed to other region; and
a changer configured to relocate the second object from the region in which the second object has been placed to the other region in response to acceptance of the request by the acceptor, wherein
the match-up is performed based on regions indicated by the object group information obtained by the obtainer as regions in which the first objects have been respectively placed and a region to which the second object has been relocated by the changer.

12. The information processing system according to claim 8, wherein the associator is configured to associate the second object selected by the selector with the user after the output outputs the output data.

13. The information processing system according to claim 8, wherein the output data output by the output contains: information indicating a region among a plurality of object placeable regions, the region on which each of the first objects included in the first object group has been placed in the match-up; and information indicating a region among a plurality of object placeable regions, the region on which the second object has been placed in the match-up.

14. The information processing system according to claim 13, wherein
the second object is associated with layout information regarding layout of the second object, and
the at least one of the user terminal and the server further comprises a determinator configured to determine a region among the plurality of object placeable regions, the region on which the second object has been placed in the match-up, based on layout information associated with the second object.

15. The information processing system according to claim 14, wherein when the second object cannot be placed based on the layout information of the second object in a region corresponding to the layout information of the second object, the output is configured to output the output data in a form enabling the user to recognize that the second object cannot be placed based on the layout information of the second object.

16. The non-transitory computer-readable recording medium according to claim 9, wherein the associating is configured to associate the second object selected by the selecting with the user after the outputting outputs the output data.

17. The non-transitory computer-readable recording medium according to claim 9, wherein the output data output by the outputting contains: information indicating a region among a plurality of object placeable regions, the region on which each of the first objects included in the first object group has been placed in the match-up; and information indicating a region among a plurality of object placeable regions, the region on which the second object has been placed in the match-up.

18. The non-transitory computer-readable recording medium according to claim 17, wherein
the second object is associated with layout information regarding layout of the second object, and
the method further comprises determining a region among the plurality of object placeable regions, the region on which the second object has been placed in the match-up, based on layout information associated with the second object.

19. The non-transitory computer-readable recording medium according to claim 18, wherein when the second object cannot be placed based on the layout information of the second object in a region corresponding to the layout information of the second object, the outputting outputs the output data in a form enabling the user to recognize that the second object cannot be placed based on the layout information of the second object.
